(19) United States
(12) Patent Application Publication
(10) Pub. No.: US 2010/0190654 A1
(43) Pub. Date: Jul. 29, 2010

(54) NANOARRAYS AND METHODS AND MATERIALS FOR FABRICATING SAME

(75) Inventors: Ginger D. Rothrock, Durham, NC (US); Robert L. Henn, Raleigh, NC (US)

Correspondence Address: MORGAN, LEWIS & BOCKIUS LLP, 1701 MARKET STREET, PHILADELPHIA, PA, 19103-2921, US

(73) Assignee: Liquidia Technologies , Inc., Research Triangle Park, NC (US)

(21) Appl. No.: 12/517,750

(22) PCT Filed: Dec. 5, 2007
(86) PCT No.: PCT/US07/86521

§ 371 Date: Jan. 8, 2010

Related U.S. Application Data
(60) Provisional application No. 60/873,136, filed on Dec. 5, 2006.

(51) Int. Cl. C40B 30/04; C40B 40/06; C40B 50/14

(52) U.S. Cl. 506/9; 506/16; 506/30

(57) ABSTRACT

A nanoarray includes a fluoropolymer array defining a plurality of cavities where each cavity has a predetermined shape and is less than about 5 micrometers in a broadest cross-sectional dimension. The nanoarray also includes a composition discretely contained in each cavity, where the composition includes a linking group for coupling with a modifying group. The nanoarray can be fabricated from fluoropolyether or perfluoropolyether.

### CROSS REFERENCE TO RELATED APPLICATIONS

This application is based off and claims priority to U.S. Provisional Application No. 60/873,136, filed Dec. 5, 2006, which is incorporated herein by reference in its entirety.

### INCORPORATION BY REFERENCE

This application cites and incorporates by reference, in their entirety, the following patent applications: PCT International Patent Application Serial NO. PCT/US04/42706, filed Dec. 20, 2004 and PCT International Patent Application Serial NO PCT/US06/23722, filed Jun. 17, 2006. Furthermore, all documents referenced herein are hereby incorporated by reference as if set forth in their entirety herein, as well as all references cited therein.

### TECHNICAL FIELD

Generally, this invention relates to micro and/or nanoarrays and analysis particles fabricated from such nanoarrays for identification and diagnostics. More specifically, materials and methods are disclosed for fabricating the micro and/or nanoarrays and analysis particles.

### ABBREVIATIONS

° C.=degrees Celsius

cm=centimeter

DBTDA≦dibutyltin diacetate

DMA=dimethylacrylate

DMPA=2,2-dimethoxy-2-phenylacetophenone

EIM=2-isocyanatoethyl methacrylate

g=grams

h=hours

Hz=hertz

IL=imprint lithography

kg=kilograms

kHz=kilohertz

kPa=kilopascal

MHz=megahertz

mL=milliliters

mm=millimeters

mmol=millimoles

m.p.=melting point

mW=milliwatts

nm=nanometers

PDMS polydimethylsiloxane

PEG poly(ethylene glycol)

PFPE=perfluoropolyether

PLA poly(lactic acid)

PP polypropylene

Ppy=poly(pyrrole)

psi=pounds per square inch

PU=polyurethane

PVDF=poly(vinylidene fluoride)

PTFE=polytetrafluoroethylene

SEM=scanning electron microscopy

Si=silicon

Tg glass transition temperature

Tm=crystalline melting temperature

TMPTA=trimethylolpropane triacrylate

μm=micrometers

UV=ultraviolet

W=watts

### BACKGROUND

Microarrays with biomolecules immobilized on solid surfaces are important tools for biological research, including genomics, proteomics, disease diagnosis, drug development, and cell analysis. Microarrays are inherently a means of spatially sorting molecular species so that the species can be independently addressed. The most common arrays are DNA microarrays, made up, of oligonucleotide probes attached to the chip surface that can be exposed to complementary targets in an unknown sample. Protein microarrays use similar concepts and principals to DNA arrays, but the handling requirements of the surface proteins and antibodies necessitate special fabrication procedures. Other microarrays with similar formats include cell microarrays, chemical compound microarrays, and tissue microassays.

All typical microarray fabrication techniques target the same objective: efficient distribution of uniform, dense arrays of small droplets of probe molecules. According to the spot formation techniques, methods are often categorized as “contact printing” and “non-contact printing.” Contact printing includes pin printing and microstamping, while non-contact printing, generally newer techniques, includes photochemical methods, inkjet, and electrospray deposition. The ideal fabrication method for the microarrays must be versatile in sequence design and easy to fabricate in a reproducible manner while minimizing_cost, solution volume, and impurities.

Contact printing methods are used to form arrays by directly contacting the printing device with the substrate. These techniques include a variety of pin printing, including nano-tip printing, and microstamping. Pin printing is a widely used technique for fabricating arrays for both small-scale laboratory and large scale industrial use. Spot uniformity and positional accuracy are key, and affected by multiple factors including sample viscosity, pin contact area, surface properties of both substrate and pin, substrate planarity, and the fabrication environment—all which make reproducibility more difficult to, achieve. Slight changes in hydrophilicity can change the spot size and shape to 50% or greater. Contamination and dust must be controlled to produce high-quality arrays with little risk of pin dogging. Nano-tip printing with scanning probe microscopes (SPM) allows the production of sub-μm spots achieving higher densities. Whether traditional pin printing methods or SPM-based methods are used, all methods of pin-printing suffer commercially from the fact that they are serial printing techniques which are time consuming. An alternative to pin-printing is microstamping, where hundreds of spots are printed in parallel using a polymeric stamp. While the microstamping process is simple and inexpensive, the amount of sample transferred from the stamp to the substrate is difficult to control, reproducibly, depending on the amount and dispersion of ink transferred to the stamp, the contact pressure, and the control of solution concentrations.

A variety of alternative approaches have been developed for non-contact printing. Inkjet technology shows the greatest promise for inexpensive, high throughput fabrication. However, there are significant drawbacks with the limitations of substrates to be used and the splashing and satellite droplets that cause contamination and irregular spot size. Electrospray deposition suffers from similar drawbacks, with the additional disadvantage that biologic species can be sensitive to the electric fields. Printing oligonucleotides using photolithography can produce very efficient high density arrays, although the method can be time consuming for patterning longer sequences and the failure of photodeprotection at any stage terminates the surface oligonucleotide. Microfeatures down to 16 μm² have been created using this technique.

Although there are a variety of microarray fabrication technologies that have emerged, no single technique has provided both an excellent quality array (uniform, high density spots) and significant throughput at reasonable cost.

### SUMMARY

According to some embodiments, a nanoarray includes a surface with a plurality of features, where each feature has a predetermined shape and has a broadest linear dimension of less than about 10 micrometers. In other embodiments, a feature has a broadest linear dimension of less than about 9 micrometers. In other embodiments, a feature has a broadest linear dimension of less than about 8 micrometers. In other embodiments, a feature has a broadest linear dimension of less than about 7 micrometers. In other embodiments, a feature has a broadest linear dimension of less than about 6 micrometers. In other embodiments, a feature has a broadest linear dimension of less than about 5 micrometers. In other embodiments, a feature has a broadest linear dimension of less than about 4 micrometers. In other embodiments, a feature has a broadest linear dimension of less than about 3 micrometers. In other embodiments, a feature has a broadest linear dimension of less than about 2 micrometers. In other embodiments, a feature has a broadest linear dimension of less than about 1 micrometer; a broadest linear dimension of less than about 750 nanometers; a broadest linear dimension of less than about 500 nanometers; a broadest linear dimension of less than about 250 nanometers; a broadest linear dimension of less than about 200 nanometers; a broadest linear dimension of less than about 100 nanometers; a broadest linear dimension of less than about 50 nanometers; or, a broadest linear dimension of less than, about 25 nanometers. In some embodiments, a feature includes a cavity in the surface, with a composition discretely contained in the cavity. In some embodiments, a feature includes a discrete particle having substantially uniform size and shape, where the features are coupled to the surface. In some embodiment, each feature has a volume less than about 150 cubic micrometers.

In certain embodiments, features are arranged in a predetermined array on the surface. The array may include a land area between adjacent features where the land area is less than about 10 micrometers. The array may include a land area between adjacent features where the land area is less than about 9 micrometers. The array may include a land, area between adjacent features where the land area is less than about 8 micrometers. The array may include a land area between adjacent features where the land area is less than about 7 micrometers. The array may include a land area between adjacent features where the land area is less than about 6 micrometers. The array may include a land area between adjacent features where the land area is less than about 5 micrometers. The array may include, a land area between adjacent features where the land area is less than about 4 micrometers. The array may include a land area between adjacent features where the land area is less than about 3 micrometers. In other embodiments, the land area is less than about 2 micrometers; the land area is less than, about 1 micrometer; the land area is less than about 750 nanometers; the land area is less than about 500 nanometers; the land area is less than about 250 nanometers; the land area is less than about 200 nanometers; the land area is less than about 100 nanometers; the land area is less than about 50 nanometers; or, the land area is less than about 25 nanometers. In some embodiments, the surface includes fluoropolyether. In certain embodiments, the surface includes perfluoropolyether. In some embodiment, the land area extending between adjacent features is non-fouling.

According to some embodiments, a feature includes at least one probe. The probe may be configured to couple with a target, such as DNA or a protein. In certain embodiments, each feature includes two or more probes. In one embodiment, at least one feature includes a first probe and a second feature includes a second probe that is different from the first probe. In some embodiments, the probe is coupled with the surface of a feature. In one embodiment, the feature includes a linking group for coupling with the probe. In another embodiment, the probe is, associated with an interior of the feature and is configured to functionalize the feature. The probe may be associated with the feature by an interaction including covalent interactions, chemical adsorption, hydrogen bonding, surface interpenetration, ionic bonding, van der Waals forces, hydrophobic interactions, magnetic interactions, dipole-dipole interactions, and mechanical interlocking.

According to one embodiment, a nanoarray includes a surface defining a plurality of cavities where each cavity has a predetermined shape and a broadest linear dimension of less than about 5 micrometers; and a plurality of features including a composition discretely contained in each cavity. The composition may be configured to bind to a target.

According to some embodiments, a method of fabricating a nanoarray includes introducing a composition into a plurality of cavities in a first mold, fabricated from a non-wetting polymer. In: some embodiments, each cavity has a predetermined shape and a largest linear dimension of less than about 5 micrometers. In certain embodiments, a probe may be coupled to the composition in the cavities in the first mold to form a feature. In some embodiments, the composition partially fills the cavity. The partially filled cavity may form a reaction chamber in an unfilled portion of the cavity. In one embodiment, a target is reacted with the probe in the partially filled cavity. In some embodiments, the composition may be cured in each cavity to form a discrete particle in each cavity. According to certain embodiments, a second mold having cavities is fabricated and positioned adjacent the first mold.

In some embodiments, a method of identifying a target in a sample includes contacting a sample including one or more targets with a nanoarray of certain embodiments of the present invention. In some embodiments, a target having an affinity for a probe is allowed to bind with the probe. In certain embodiments, the features associated with the target bound probes may be detected and cross referenced with a library of what probe is associated with the feature to determine a composition of the target.

### BRIEF DESCRIPTION OF THE DRAWINGS

Reference is made to the accompanying drawings which show illustrative embodiments of the present invention and which should be read in connection with the description of the invention.

FIG. 1 is a schematic representation of a patterned nanoarray according to an embodiment of the present invention;

FIGS. 2A-2D are schematic representations of functionalized particles according to one embodiment of the present invention;

FIGS. 3A-3D are schematic representations of functionalized particles according to another embodiment of the present invention;

FIGS. 4A-4F shows schematics of a nanoarray with probes according to an embodiment of the present invention;

FIGS. 5A-5F shows schematics of a nanoarray having attached probes according to another embodiment of the present invention

FIGS. 6A-6F shows schematics of a nanoarray of particles with attached probes or samples according to an embodiment of the present invention;

FIGS. 7A-7D shows schematics of nanoarrays and nanoparticles as diagnostics according to an embodiment of the present invention;

FIGS. 8A-8C shows a micro patterned master, replicate mold, and microarray fabricated from the replicate nanoarray according to an embodiment of the present invention;

FIG. 9 shows particles harvested from a replicate nanoarray for use as diagnostics according to an embodiment of the pressent invention;

FIG. 10 shows a 1 micrometer microarray with 2 micrometer pitch nanoarray filled with diagnostic particles according to an embodiment of the present invention;

FIGS. 11A-11B shows a 200 nanometer master and nanoarray produced therefrom according to an embodiment of the present invention;

FIG. 12 is a scanning electron micrograph of a silicon master including 200 nm trapezoidal patterns according to an embodiment of the present invention;

FIGS. 13A-13C are fluorescence confocal micrographs of 200-nm isolated trapezoidal particles of PEG diacrylate that contain fluorescently tagged DNA, according to an embodiment of the present invention; FIG. 13A is a fluorescent confocal micrograph of 200 nm trapezoidal PEG nanoparticles which contain 24-mer DNA strands that are tagged with CY-3; FIG. 13B is optical micrograph of the 200-nm isolated trapezoidal particles of PEG diacrylate that contain fluorescently tagged DNA; and FIG. 13C is the overlay of the images provided in FIGS. 13A and 13B, showing that every particle contains DNA;

FIG. 14 shows a structure patterned with nano-cylindrical shapes according to an embodiment of the present invention;

FIG. 15 shows 2×2×1 μm pDNA containing positively charged PEG particles: Top Left: SEM, Top Right: DIC, Bottom Left: Particle-bound Polyflour 570 flourescence, Bottom Right: Fluorescein-labelled control plasmid fluorescence according to embodiments of the present invention;

FIG. 16 shows master templates containing 200 nm cylindrical shapes with varying aspect ratios according to an embodiment of the present invention;

FIG. 17 shows scanning electron micrograph (at a 45° angle) of harvested neutral PEG-composite 200 nm (aspect ratio=1:1) particles on the poly(cyanoacrylate) harvesting layer according to an embodiment of the present invention;

FIG. 18 shows a reaction scheme for conjugation of a radioactively labeled moiety to PRINT particles according to an embodiment of the present invention;

FIG. 19 shows tethering avidin to a CDI linker according to an embodiment of the present invention; and

FIG. 20 shows fabrication of PEG particles that target an HER2 receptor according to an embodiment of the present invention.

### DETAILED DESCRIPTION

The present invention will now be described more fully hereinafter with reference to the accompanying Figures and Examples, in which representative embodiments are shown. The present invention can, however, be embodied in different forms and should not be construed as limited to the embodiments set forth herein. Rather, these embodiments are provided so that this disclosure is thorough and complete, and will fully convey the scope of the embodiments to those skilled in the art. Unless otherwise defined, all technical and scientific terms used herein have the same meaning as commonly understood by one of ordinary skill in the art to which this present invention belongs. All publications, patent applications, patents, and other references mentioned herein are incorporated by reference in their entirety. Throughout the specification and claims, a given chemical formula or name shall encompass all optical and stereoisomers, as well as racemic mixtures where such isomers and mixtures exist.

I. Non-Exhaustive List of Definitions

As used herein, the term “pattern” can mean an array, a matrix, specific shape or form, a template of the article of interest, or the like. In some embodiments, a pattern can be ordered, uniform, repetitious, alternating, regular, irregular, or random arrays or templates. The patterns of the present invention can include one or more of a micro- or nano-sized reservoir, a micro- or nano-sized reaction chamber, a micro- or nano-sized mixing chamber, a micro- or nano-sized collection chamber. The patterns of the present invention can also include a surface texture or a pattern on a surface that can include micro- and/or nano-sized cavities. The patterns can also include micro- or nano-sized projections.

As typical in polymer chemistry the term “perfluoropolyethers” herein should be understood to represent not only its purest form, i.e., the polymeric chain built from three elements—carbon, oxygen, and fluorine, but variations of such structures. The base family of perfluoropolyethers itself includes linear, branched, and functionalized materials. The use within this patent also includes some substitution of the fluorine with materials such as H, and other halides; as well as block or random copolymers to modify the base perfluoropolyethers.

As used herein, the term “monolithic” refers to a structure having or acting as a single, uniform structure.

As used herein, the term “non-biological organic materials” refers to organic materials, i.e., those compounds that include covalent carbon-carbon bonds, other than biological materials.

As used herein, the term “biological materials” includes nucleic acid polymers (e.g., DNA, RNA) amino acid polymers (e.g., enzymes, proteins, and the like) and small organic compounds (e.g., steroids, hormones) wherein the small organic compounds have biological activity, especially biological activity for humans or commercially significant animals, such as pets and livestock, and where the small organic compounds are used primarily for therapeutic or diagnostic purposes. While biological materials are of interest with respect to pharmaceutical and biotechnological applications, a large number of applications involve chemical processes that are enhanced by other than biological materials, i.e., non-biological organic materials.

As used herein, the term “partial cure” refers to a condition wherein less than about 100% of a polymerizable group of a material is reacted. In certain embodiments, the term “partially-cured material” refers to a material that has undergone a partial cure process or treatment.

As used herein, the term “full cure” refers to a condition wherein about 100% of a polymerizable group of a material is reacted. In certain embodiments, the term “fully-cured material” refers to a material which has undergone a full cure process or treatment. In some cases, “fully cured material” includes a small amount of material which is unreacted, due to limitations such as steric limitations.

As used herein, the term “photocured” refers to a reaction of polymerizable groups whereby the reaction can be triggered by actinic radiation, such as UV light. In this application UV-cured can be a synonym for photocured.

As used herein, the term “thermal cure” or “thermally cured” refers to a reaction of polymerizable groups, whereby the reaction can be triggered or accelerated by heating the material beyond a threshold temperature.

Following long-standing patent law convention, the terms “a”, “an”, and “the” refer to “one or more” when used in this application, including the claims. Thus, for example, reference to “a cavity” includes a plurality of such cavities, and so forth.

II. Materials

The present subject matter broadly describes micro and nanoarrays fabricated from solvent resistant, low surface energy polymeric materials, derived from casting the low viscosity liquid materials onto a master template and then curing the low viscosity liquid materials to generate a patterned template for use in high-resolution, high-density, and high-precision, micro or nanoarrays. In some embodiments, the nanoarray or mold includes a solvent resistant elastomer-based material, such as but not limited to a fluoropolymer, such as for example, fluorinated elastomer-based materials such as fluoropolyether and perfluoropolyether. Further, the present invention describes nanomolding of organic materials to generate high fidelity functionalized micro- or nanostructures or micro- or nanoparticles (hereinafter referred to as “nanoparticles” or “particles”) for use as diagnostic tools. Accordingly, the free-standing, isolated nanoparticles can be fabricated of virtually any shape using the techniques disclosed herein and incorporated herein by reference.

In some embodiments, a nanoparticle of the present invention is fabricated in a non-wetting polymer mold. The mold may have cavities of a substantially predetermined shape. In some embodiments, the mold cavity has a volume of less than 150 μm³. In some embodiments, a nanoparticle is, fabricated by introducing a composition into a mold cavity. In some embodiments, a particle is formed from the composition in the cavity. The particles may then be extracted from the mold cavity. The molds, materials, and methods are described in greater detail below and in the references incorporated herein.

The nanoparticles of some embodiments of the present invention are molded in low surface energy molds according to methods and materials described in the following patent applications: WO. 07/024,323 (PCT International Application Serial No PCT/US06123722), filed Jun. 19, 2006; WO 07/030,698 (PCT. International Patent Application Serial No. PCT/US06/034997), filed Sep. 7, 2006); WO 05/01466 (PCT International Patent Application Serial No PCT/US04/42706), filed Dec. 20, 2004; WO 05/030822 (PCT International Application Serial No. PCT/US04/31274), filed Sep. 23, 2004; WO 05/084191 (PCT International Patent Application Serial No PCT/US05/04421), filed Feb. 14, 2005; and PCT International Application Serial No PCT/US06/31067, filed Aug. 9, 2006; each of which is incorporated herein by reference in its entirety including all references cited therein.

According to certain embodiments of the present invention, “curing” a liquid polymer, for example a liquid PFPE used to form the molds, means transforming the polymer from a liquid state to a non-liquid state (excluding a gas state) such that the polymer does not readily flow, such as a material with a relatively high viscosity or a rubbery state. In some embodiments, the non-liquid state that the polymer is transformed to is a gel state. In some embodiments, the polymer in the non-liquid state can include un-reacted polymerizable groups. In other embodiments, the polymer liquid precursor is capable of undergoing a first cure to become non-liquid such that the polymer becomes not fully soluble in a solvent. In other embodiments, when the liquid polymer precursor is cured it is meant that the polymer has transitioned into a non-liquid polymer that forms fibers about an object drawn through the material. In other embodiments, an initial cure of the liquid polymer precursor transitions the polymer to a non-conformable state at room temperature. In other embodiments, following a cure, the polymer takes a gel form, wherein gel means an article that is free-standing or self-supporting in that its yield value is greater than the shear stress imposed by gravity.

Representative solvent resistant elastomer-based materials include but are not limited to fluorinated elastomer-based materials. As used herein, the term “solvent resistant” refers to a material, such as an elastomeric material that neither swells nor dissolves in common hydrocarbon-based organic solvents or acidic or basic aqueous solutions. Representative fluorinated elastomer-based materials include but are, not limited to fluoropolyether and perfluoropolyether (collectively PFPE) based materials. The materials of the present invention further include photocurable and/or thermal curable components such that the PFPE materials can be cured from a liquid to a solid upon application of a treatment such as actinic radiation or thermal energy. PFPE materials and modified. PFPE materials that are applicable to making the molds of the present invention are described herein and further in the applications incorporated by reference, and it will be appreciated that the materials described herein can be combined in numerous ways to form different materials of the present invention, each of which is included in the present invention.

A representative scheme for the synthesis and photocurable functional PFPE is provided in Scheme 1.

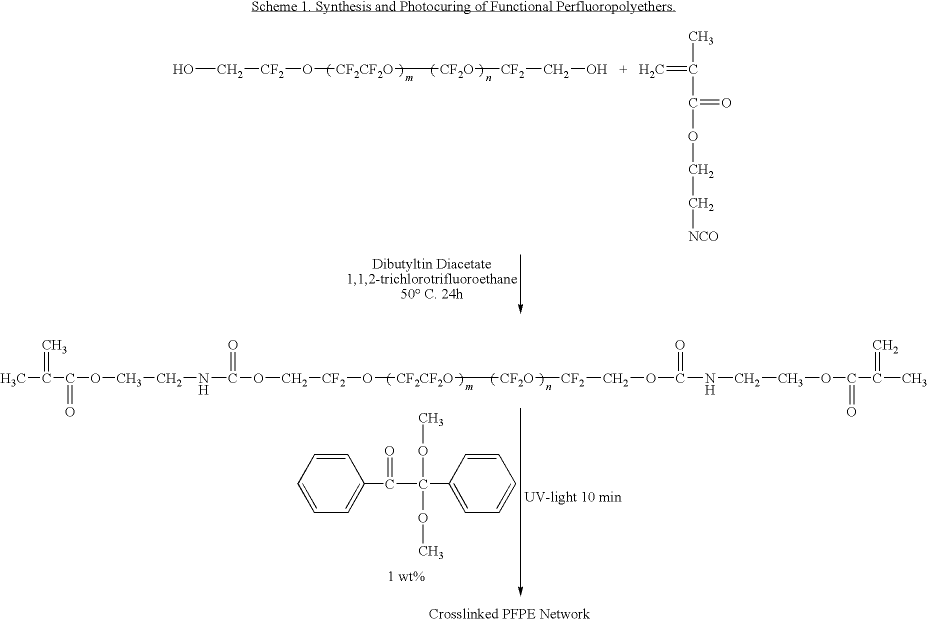

Additional schemes for the synthesis of functional perfluoropolyethers are provided herein, including in the Examples.

According to another embodiment, a material for use in the molds of the present invention includes one or more of a photo-curable constituent, a thermal-curable constituent, and mixtures thereof. In one embodiment, the photo-curable constituent is independent from the thermal-curable constituent such that the material can undergo multiple cures. A material having the ability to undergo multiple cures is useful, for example, in forming layered articles or laminates. For example, a liquid material having photo-curable and thermal-curable constituents can undergo a first cure to form a first article through, for example, a photocuring process or a thermal curing process. Then the photocured or thermal cured first article can be adhered to a second article of the same material or virtually any material similar thereto that will thermally cure or photocure and bind to the material of the first article. By positioning the first article and second article adjacent one another and subjecting the first and second articles to a thermalcuring or photocuring process, whichever component that was not activated on the first curing can be cured by a subsequent curing step. Thereafter, either the thermalcure constituents of the first article that was left un-activated by the photocuring process or the photocure constituents of the first article that were left un-activated by the first thermal curing, will be activated and bind the second article. Thereby, the first and second articles become adhered together. It will be appreciated by one of ordinary skill in the art that the order of curing processes is independent and a thermal-curing could occur first followed by a photocuring or a photocuring could occur first followed by a thermal curing.

According to yet another embodiment, multiple thermo-curable constituents can be included in the material such that the material can be subjected to multiple independent thermal-cures. For example, the multiple thermo-curable constituents can have different activation temperature ranges such that the material can undergo a first thermal-cure at a first temperature range and a second thermal-cure at a second temperature range.

According to yet another embodiment, multiple independent photo-curable constituents can be included in the material such that the material can be subjected to multiple independent photo-cures. For example, the multiple photo-curable constituents can have different activation wavelength ranges such that the material can undergo a first photo-cure at a first wavelength range and a second photo-cure at a second wavelength range.

According to some embodiments, curing of a polymer or other material, solution, dispersion, or the like includes hardening, such as for example by chemical reaction like a polymerization, phase change, a melting transition (e.g. mold above the melting point and cool after molding to harden), evaporation, combinations thereof, and the like.

According to one, embodiment the materials disclosed herein have a surface energy below about 30 mN/m. According to another embodiment the surface energy of the material is between about 10 mN/m and about 20 mN/m. According to another embodiment, the material has a low surface energy of between about 12 mN/m and about 15 mN/m. The material is also non-toxic, UV transparent, and highly gas permeable; and cures into a tough, durable, highly fluorinated elastomer with excellent release properties and resistance to swelling. The properties of these materials can be tuned over a wide range through the judicious choice of additives, fillers, reactive co-monomers, and functionalization agents. Such properties that are desirable to modify, include, but are not limited to, modulus, tear strength, surface energy, permeability, functionality, mode of cure, solubility and swelling characteristics, and the like. The non-swelling nature, easy release properties, and gentile processing steps (low or room temperatures, no acidic or basic processing steps, etc) of the materials to form nanoarrays allows for the nanoarrays to include virtually any composition, such as biologics or organics. Further, the presently disclosed subject matter can be expanded to large scale rollers or conveyor belt technology or rapid stamping that allow for high throughput fabrication of nanoarrays and diagnostic nanostructures.

In some embodiments, at least one of the nanoarray and substrate includes a material selected from the group including a perfluoropolyether material, a fluoroolefin material, an acrylate material, a silicone material, a styrenic material, a fluorinated thermoplastic elastomer (TPE), a triazine fluoropolymer, a perfluorocylobutyl material, a fluorinated epoxy resin, and a fluorinated monomer or fluorinated oligomer that can be polymerized or crosslinked by a metathesis polymerization reaction.

In some embodiments, the perfluoropolyether material includes a backbone structure selected from the group including:

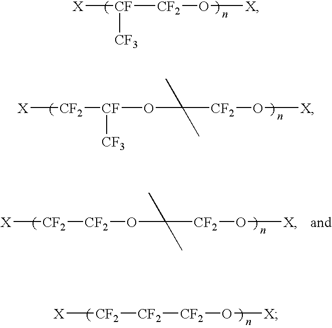

wherein X is present or absent, and when present includes an endcapping group.

In some embodiments, the fluoropolymer is further subjected to a fluorine treatment after curing. In some embodiments, the fluoropolymer is subjected to elemental fluorine after curing.

In some embodiments the liquid PFPE precursor includes a chain extended material such that two or more chains are linked together before adding polymerizablable groups. Accordingly, in some embodiments, a “linker group” joins two chains to one molecule. In some embodiments, the linker group joins three or more chains. In some embodiments, the liquid PFPE precursor includes a hyperbranched polymer

In some embodiments, X is selected from the group consisting of an isocyanate, an acid chloride, an epoxy, and a halogen. In some embodiments, R is selected from the group consisting of an acrylate, a methacrylate, a styrene, an epoxy, a carboxylic, an anhydride, a maleimide, an isocyanate, an olefinic, and an amine. In some embodiments, the circle represents any multifunctional molecule. In some embodiments, the multifunctional molecule includes a cyclic molecule. PFPE refers to any PFPE material provided hereinabove.

In some embodiments the PFPE liquid precursor is encapped with an epoxy moiety that can be photocured using a photoacid generator. In some embodiments the liquid PFPE precursor cures into a highly UV and/or highly visible light transparent elastomer. In some embodiments the liquid PFPE precursor cures into an elastomer that is highly permeable to oxygen, carbon dioxide, and nitrogen, a property that can facilitate maintaining the viability of biologicals disposed therein. In some embodiments, additives are added or layers are created to enhance the barrier properties of the article to molecules, such as oxygen, carbon dioxide, nitrogen, dyes, reagents, and the like.

In some embodiments, the material suitable for use with the presently disclosed subject matter includes a silicone material having a fluoroalkyl functionalized polydimethylsiloxane (PDMS). In some embodiments, the material suitable for use with the presently disclosed subject matter includes a styrenic material having a fluorinated styrene monomer. In some embodiments, the material suitable for use with the presently disclosed subject matter includes an acrylate material having a fluorinated acrylate or a fluorinated methacrylate. In some embodiments, the material suitable for use with the presently disclosed subject matter includes a triazine fluoropolymer having a fluorinated monomer.

In some embodiments, the fluorinated monomer or fluorinated oligomer that can be polymerized or crosslinked by a metathesis polymerization reaction includes a functionalized olefin. In some embodiments, the functionalized olefin includes a functionalized cyclic olefin.

According to an alternative embodiment, the PFPE material includes a urethane block. According to an embodiment of the present invention, PFPE urethane tetrafunctional methacrylate materials can be used as the materials and methods of the present invention or can be used in combination with other materials and methods described herein, as will be appreciated by one of ordinary skill in the art. For example, a four-part material (A-D) can be used, where part A is a UV curable precursor and parts B and C make up a thermally curable, component of the urethane system. The fourth component, part D, is a end-capped precursor, (e.g., styrene end-capped liquid precursor). According to some embodiments, part D reacts with latent methacrylate, acrylate, or styrene groups contained in a base material, thereby adding chemical compatibility or a surface passivation to the base material and increasing the functionality of the base material.

Further, in some embodiments, the materials used herein are selected from highly fluorinated fluoroelastomers, e.g., fluoroelastomers having at least fifty-eight weight percent fluorine, as described in U.S. Pat. No. 6,512,063 to Tang, which is incorporated herein by reference in its entirety. Such fluoroelastomers can be partially fluorinated or perfluorinated and can contain between 25 to 70 weight percent, based on the weight of the fluoroelastomer, of copolymerized units of a first monomer, e.g., vinylidene fluoride (VF₂) or tetrafluoroethylene (TFE). These fluoroelastomers include VITON® (DuPont Dow Elastomers, Wilmington, Del., United States of America) and Kel-F type polymers, as described in U.S. Pat. No. 6,408,878 to Unger et al. More particularly, the fluorine-containing olefins include, but are not limited to, vinylidine fluoride, hexafluoropropylene (HFP), tetrafluoroethylene (TFE), 1,2,3,3,3-pentafluoropropene (1-HPFP), chlorotrifluoroethylene (CTFE) and vinyl fluoride. The fluorine-containing vinyl ethers include, but are not limited to perfluoro(alkyl vinyl)ethers (PAVEs). In embodiments wherein copolymerized units of a perfluoro(alkyl vinyl)ether (PAVE) are present in the presently described fluoroelastomers, the PAVE content generally ranges from 25 to 75 weight percent, based on the total weight of the fluoroelastomer. If the PAVE is perfluoro(methyl vinyl)ether (PMVE), then the fluoroelastomer contains between 30 and 55 wt. % copolymerized PMVE units.

Hydrocarbon olefins useful in the presently described fluoroelastomers include, but are not limited to ethylene (E) and propylene (P). In embodiments wherein copolymerized units of a hydrocarbon olefin are present in the presently described fluoroelastomers, the hydrocarbon olefin content is generally 4 to 30 weight percent. Further, the presently described fluoroelastomers can in some embodiments, include units of one or more cure site monomers. Examples of suitable cure site monomers include: i) bromine-containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl)ether; and ix) non-conjugated dienes.

According to other embodiments of the present invention, a dual cure material includes one or more of a photo-curable constituent and a thermal-curable constituent. In one embodiment, the photo-curable constituent is independent from the thermal-curable constituent such that the material can undergo multiple cures. A material having the ability to undergo multiple cures is useful, for example, in forming layered articles or in connecting or attaching articles to other articles or portions or components of articles to other portions or components of articles. For example, a liquid material having photocurable and thermal-curable constituents can undergo a first cure to form a first article through, for example, a photocuring process or a thermal curing process. Then the photocured or thermal cured first article can be adhered to a second article of the same material or any material similar thereto that will thermally cure or photocure and bind to the material of the first article. By positioning the first article and second article adjacent one another and subjecting the first and second articles to a thermal curing or photocuring, whichever component that was not activated on the first curing. Thereafter, either the thermal cure constituents of the first article that were left un-activated by the photocuring process or the photocure constituents of the first article that were left un-activated by the first thermal curing, will be activated and bind the second article. Thereby, the first and second articles become adhered together. It will be appreciated by one of ordinary skill in the art that the order of curing processes is independent and a thermal-curing could occur first followed by a photocuring or a photocuring could occur first followed by a thermal curing.

According to yet another embodiment, dual cure materials can include multiple thermal curable constituents included in the material such that the material can be subjected to multiple independent thermal-cures. For example, the multiple thermal curable constituents can have different activation temperature ranges such that the material can undergo a first thermal-cure at a first temperature range and a second thermal-cure at a second temperature range. Accordingly, the material can be adhered to multiple other materials through different thermal-cures, thereby, forming a multiple laminate layer article.

According to another embodiment, dual cure materials can include materials having multiple photo curable constituents that can be triggered at different wavelengths. For example, a first photo curable constituent can be triggered at a first applied wavelength and such wavelength can leave a second photo curable constituent available for activation at a second wavelength.

Accordingly, the presently disclosed methods can be used to adhere layers of different polymeric materials together to form articles, such as laminate arrays, and the like.

According to alternate embodiments, novel silicone based materials include photocurable and thermal-curable components. In such alternate embodiments, silicone based materials can include one or more photo-curable and thermal-curable components such that the silicone based material has a dual curing capability as described herein. Silicone based materials compatible with the present invention are described herein and throughout the reference materials incorporated by reference into this application.

According to some embodiments, articles and methods disclosed herein can be formed with materials that include phosphazene-containing polymers having the following structure. According to these embodiments, the materials, can contain a fluorine-containing alkyl chain. Examples of such fluorine-containing alkyl chains can be found in Langmuir, 2005, 21, 11604, the disclosure of which is incorporated herein by reference in its entirety. The articles disclosed in this application can be formed from phosphazene-containing polymers or from PFPE in combination with phosphazene-containing polymers.

In some embodiments, articles and methods disclosed herein can be formed with materials that include materials end-capped with one or more aryl trifluorovinyl ether (TVE) group. Examples of materials end-capped with a WE group can be found in Macromolecules, 2003, 36, 9000, which is incorporated herein by reference in its entirety. These structures react in a 2+2 addition at about 150° C. to form perfluorocydobutyl moieties. In some embodiments, Rf can be a PFPE chain. In some embodiments three or more TVE groups are present on a 3-armed PFPE polymer such that the material crosslinks into a network.

In some embodiments a sodium naphthalene etchant, such as commercially available Tetraetch™, is contacted with a layer of a fluoropolymer article, such as an article disclosed herein. In other embodiments, a sodium naphthalene etchant is contacted with a layer of a PFPE-based article, such as a microarray disclosed herein. According to such embodiments, the etch reacts with C—F bonds in the polymer of the article forming functional groups along a surface of the article. In some embodiments, these functional groups can then be reacted with modalities on other layers, on a silicon surface, on a glass surface, combinations thereof, or the like, thereby forming an adhesive bond. In some embodiments, such adhesive bonds available on the surface of articles disclosed herein, such as microarrays, can increase adhesion between two articles, layers of an article, combinations thereof, or the like.

According to some embodiments, a trifunctional PFPE precursor can be used to fabricate articles disclosed herein, such as microarrays. The trifunctional PFPE precursor disclosed herein can increase the functionality of an overall article by increasing the number of functional groups that can be added to the material. Moreover, the trifunctional PFPE precursor can provide for increased cross-linking capabilities of the material.

In some embodiments, functional PFPEs or other fluoropolymers can be generated using fluoroalkyliodide precursors. According to such embodiments, such materials can be modified by insertion of ethylene and then transformed into a host of common functionalities including but not limited to: silanes, Gringard reagents, alcohols, cyano, thiol, epoxides, amines, and carboxylic acids.

According to some embodiments, one or more of the PFPE precursors useful for fabricating articles disclose herein, such as microarrays for example, contains diepoxy materials. The diepoxy materials can be synthesized by reaction of PFPE diols with epichlorohydrin.

In some embodiments, PFPE chains can be encapped with cycloaliphatic epoxides moieties such as cyclohexane epoxides, cyclopentane epoxides, combinations thereof, or the like. In some embodiments, the PFPE diepoxy is a chain-extending material synthesized by varying the ratio of diol to epichlorohydrin during the synthesis. Examples of some synthesis procedures are described by Tonelli et al. in Journal of Polymer Science: Part A: Polymer Chemistry 1996, Vol 34, 3263, which is incorporated herein by reference in its entirety. Utilizing this method, the mechanical properties of the cured material can be tuned to predetermined standards. In further embodiments, the secondary alcohol formed in this reaction can be used to attach further functional groups. For example, the secondary alcohol can be reacted with 2-isocyanatoethyl methacrylate to yield a material with species reactive towards both free radical and cationic curing. Functional groups such as in this example can be utilized to bond surfaces together, such as for example, layers of PFPE material in a microarray. In still further embodiments, moieties on a surface of a microarray such as biomolecules, proteins, charged species, catalysts, etc. can be attached through such secondary alcohol species.

In some embodiments, PFPE diepoxy can be cured with traditional diamines, including but not limited to, 1,6 hexanediamine; isophorone diamine; 1,2 ethanediamine; combinations thereof; and the like. According to some embodiments the diepoxy can be cured with imidazole compounds. In some embodiments the PFPE diepoxy containing an imidazole catalyst is the thermal part of a two cure system, such as described elsewhere herein.

In some embodiments, a PFPE diepoxy can be cured through the use of photoacid generators (PAGs). The PAGs are dissolved in the PFPE material in concentrations ranging from between about 1 to about 5 mol % relative to epoxy groups and cured by exposure to UV light. Specifically, for example, these photoacid generators can be Rhodorsil™ 2074 (Rhodia, Inc). In other embodiments, the photoacid generator can be, for example, Cyracure™ (Dow Corning).

In some embodiments, a commercially available PFPE diol containing a said number of poly(ethylene glycol) units, such as those commercially sold as ZDOL TX™ (Solvay Solexis) can be used as the material for fabrication of an article, such as a microarray. In other embodiments, the commercially available PFPE diol containing a given number of poly(ethylene glycol) units is used in combination with other materials disclosed herein. Such materials can be useful for dissolving the above described photoinitiators into the PFPE diepoxy and can also be helpful in tuning mechanical properties of the material as the PFPE diol containing a poly(ethylene glycol)unit can react with propagating epoxy units and can be incorporated into the final network.

In further embodiments, commercially available PFPE diols and/or polyols can be mixed with a PFPE diepoxy compound to tune mechanical properties by incorporating into the propagating epoxy network during curing.

In some embodiments, a PFPE epoxy-containing a PAG can be blended with between about 1 and about 5 mole % of a free radical photoinitiator. These materials, when blended with a PAG, form reactive cationic species which are the product of oxidation by the PAG when the free-radical initiators are activated with UV light, as partially described by Crivello et al. Macromolecules 2005, 38, 3584, which is incorporated herein by reference in its entirety. Such cationic species can be capable of initiating epoxy polymerization and/or curing. The use of this method allows the PFPE diepoxy to be cured at a variety of different wavelengths.

In some embodiments, a PFPE diepoxy material containing a photoacid generator can be blended with a PFPE dimethacrylate material containing a free radical photoinitiator. The blended material includes a dual cure material which can be cured at one wavelength, for example, curing the dimethacrylate at 365 nm, and then bonded to other layers of material through activating the curing of the second diepoxy material at another wavelength, such as for example 254 nm. In this manner, multiple layers of patterned PFPE materials can be bonded and adhered to other substrates such as glass, silicon, other polymeric materials, combinations thereof, and the like at different stages of fabrication of an overall article.

In some embodiments, the material is or includes diurethane methacrylate having a modulus of about 4.0 MPa and is UV curable. In some embodiments, the material is or includes a chain extended diurethane methacrylate, wherein chain extension before end-capping increases molecular weight between crosslinks, a modulus of approximately 2.0 MPa, and is UV curable. In some embodiments, the material is typically one component of a two-component thermally curable system and may be cured by itself through a moisture cure technique. In some embodiments, the material is or, includes, one component of a two component thermally curable system, chain extended by linking several PFPE chains together, and may be cured by itself through a moisture cure. In some embodiments, the material is a blocked diisocyanate. In some embodiments, the material is a PFPE three-armed triol. In some embodiments, the material is a UV curable PFPE distyrene. In some embodiments, the material is a diepoxy, diamine, diisocyanate, or combinations of thereof. In some embodiments, the material is a thermally cured PU tetrol or PU triol.

According to alternative embodiments, the following materials can be utilized alone, in connection with other materials disclosed herein, or modified by other materials disclosed here and applied to the methods disclosed herein to fabricate the articles disclosed herein. Moreover, end-groups disclosed herein and disclosed in U.S. Pat. Nos. 3,810,874; and 4,818,801, each of which is incorporated herein by reference including all references cited therein.

From a property point of view, the exact properties of these materials can be adjusted by adjusting the composition of the ingredients used to make the materials, as should be appreciated by one of ordinary skill in the art.

III. NANOARRAYS

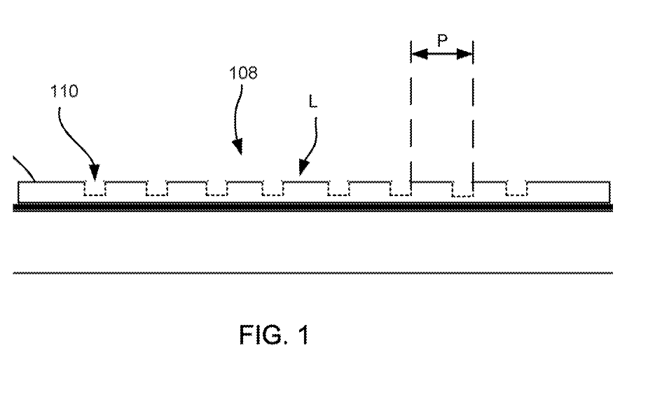

In some embodiments, the materials and methods of the present invention provide low-surface energy molds with neatly arranged cavities that can function as highly ordered, high density, highly discrete test-spots, or features, for micro and/or nanoarrays. The materials also provide the nanoarray with properties that render land area L (FIG. 1), the surface between cavities, non-wetting and non-adhesive; or substantially non-wetting and substantially non-adhesive to probe and target molecules or species, as described more herein. According to some embodiments, the molds form nanoarray surfaces as planar sheets defining neatly arranged cavities containing a substance. The cavity/substance combination forms a spot or feature that can be used as a probe or to bind a probe for analyzing targets in a sample. In other embodiments, the substances in the cavities can be formed into particles and harvested from the cavities to form features that are either independent and discrete or features that are coupled with a substrate in the neat orderly array mimicking the array of cavities from which they were formed.

Features

In some embodiments, the nanoarray includes a surface having a plurality of cavities that can be filled or partially filled to form features. The features may each include at least one probe. In some embodiments, the probe is configured to couple with a target. In certain embodiments, a feature may include a cavity containing a composition. In other embodiments, a feature may include a particle formed in a cavity and coupled to a surface or substrate. In some embodiments, a feature may have a volume of less than about 150 μm³.

In certain embodiments, a surface includes features arranged in a predetermined array. According to some embodiments, the features are arranged in a predetermined density. In certain, embodiments, the features are arranged with a predetermined land area between the features. In some embodiments, the features are arranged with a predetermined distance between adjacent features. In some embodiments, a distance between adjacent features is less than about 10 micrometers. In some embodiments, a distance between adjacent features is less than about 9 micrometers. In some embodiments, a distance between adjacent features is less than about 8 micrometers. In some embodiments, a distance between adjacent features is less than about 7 micrometers. In some embodiments, a distance between adjacent features is less than about 6 micrometers. In some embodiments, a distance between adjacent features is less than about 5 micrometers. In some embodiments, a distance between adjacent features is less than about 4 micrometers. In some embodiments, a distance between adjacent features is less than about 3 micrometers. In other embodiments, a distance between adjacent features is less than about 2 micrometers. In other embodiments, a distance between adjacent features is less than about 1 micrometer. In other embodiments, a distance between adjacent features is less than about 750 nanometers. In other embodiments, a distance between adjacent features is less than about 500 nanometers. In other embodiments, a distance between adjacent features is less than about 250 nanometers. In other embodiments, a distance between adjacent features is less than about 200 nanometers. In other embodiments, a distance between adjacent features is less than about 100 nanometers. In other embodiments, a distance between adjacent features is less than about 50 nanometers. In other embodiments, a distance between adjacent features is less than about 25 nanometers.

In some embodiments, the surface may include features having predetermined size and/or shape. In some embodiments, the features have a substantially uniform size and/or shape. In some embodiments the features of a nanoarray have a substantially uniform size distribution. In such embodiments, features have a normalized size distribution of between about 0.80 and about 1.20, between about 0.90 and about 1.10, between about 0.95 and about 1.05, between about 0.99 and about 1.01, between about 0.999 and about 1.001, combinations thereof, and the like. Furthermore, in other embodiments the features of a nanoarray have a mono-dispersity. According to some embodiments, dispersity is calculated by averaging a dimension of the features. In some embodiments, the dispersity is based on, for example, surface area, length, width, height, mass, volume, porosity, combinations thereof, and the like.

In some embodiments, a feature has a broadest linear dimension of 10 micrometers. In some embodiments, a feature has a broadest linear dimension of 9 micrometers. In some embodiments, a feature has a broadest linear dimension of 8 micrometers. In some embodiments, a feature has a broadest linear dimension of 7 micrometers. In some embodiments, a feature has a broadest linear dimension of 6 micrometers. In some embodiments, a feature has a broadest linear dimension of 5 micrometers. In some embodiments, a feature has a broadest linear dimension of 4 micrometers. In some embodiments, a feature has a broadest linear dimension of 3 micrometers. In some embodiment, a feature has a broadest linear dimension of less than about 2 micrometers. In some embodiment a feature has a broadest linear dimension of less than about 1 micrometer. In some embodiments, a feature has a broadest linear dimension of less than about 750 nanometers. In some embodiments, a feature has a broadest linear dimension of less than about 500 nanometers. In some embodiments, a feature has a broadest linear dimension of less than about 250 nanometers. In some embodiments, a feature has a broadest linear dimension of less than about 200 nanometers. In some embodiments, a feature has a broadest linear dimension of less than about 100 nanometers. In some embodiments, a feature has a broadest linear dimension of less than about 50 nanometers. In some embodiments, a feature has a broadest linear dimension of less than about 25 nanometers.

Cavity Features

According to some embodiments, a surface includes a plurality of cavities. The surface may be a mold as described herein, including a plurality of cavities. The cavities may be arranged in a predetermined array. In some embodiments, the cavities have a predetermined size and/or shape. In some embodiments, a cavity has a broadest linear dimension of 5 micrometers. In some embodiment, a cavity has a broadest linear dimension of less than about 2 micrometers. In some embodiment, a cavity has a broadest linear dimension of less than about 1 micrometer. In some embodiments, a cavity has a broadest linear dimension of less than about 750 nanometers. In some embodiments, a cavity has a broadest linear dimension of less than about 500 nanometers. In some embodiments, a cavity has a broadest linear dimension of less than about 250 nanometers. In some embodiments, a cavity has a broadest linear dimension of less than about 200 nanometers. In some embodiments, a cavity has a broadest linear dimension of less than about 100 nanometers. In some embodiments, a cavity has a broadest linear dimension of less than about 50 nanometers. In some embodiments, a cavity has a broadest linear dimension of less than about 25 nanometers.

In some embodiments, the materials form laminate nanoarrays having nano-sized and/or micron-sized predetermined shape cavities. Referring now to FIG. 1, general laminate nanoarray 100 of the present invention may include backing layer 102 affixed to patterned replica layer 104 by tie-layer 106. In certain embodiments, tie-layer 106 is used to bond replica layer 104 to backing layer 102. In certain other embodiments, replica layer 104 binds directly with backing layer 102 and tie-layer 106 is not utilized. According to some embodiments, patterned replica layer 104 includes a patterned surface 108. In some embodiments, patterned surface 108 is obtained by introducing replica layer 104, in its liquid state to a patterned master, such as for example an etched silicon master. Replica layer 104 can be made from the materials disclosed herein, and combinations thereof such that replica layer 104 has properties to conform to nano shaped patterns of a patterned master and be curable by UV and/or thermal exposure. Patterns on patterned surface 108 can include cavities 110 and land area L that extends between cavities 110. Patterns on patterned surface 108 can also include a pitch, such as pitch P, which is generally the distance from a first edge of one cavity 110 to a first edge of an adjacent cavity including land area L between the adjacent cavities 110.

In some embodiments, a cavity includes a composition. In some embodiments, a cavity including a composition defines a feature. In some embodiments, the composition includes a precursor composition. In some embodiments, the composition completely fills the cavity. In other embodiments, the composition partially fills the cavity such that the unfilled portion of the partially filled cavity may form a reaction chamber. Based on the size of the cavities of the present nanoarrays, partially filled cavities result in reaction chambers that require very small volumes of sample. Totaling this volume among cavities across an array having a footprint of several square centimeters still results in a small volume of sample required for testing. Furthermore, because the materials of the nanoarrays are formed from the low surface-energy materials described herein, the sample is encouraged to accumulate in the cavities and not on the land area, L. Therefore, since little to no sample resides or fouls the land area, L, a minimal sample size is needed to effectively present targets within the sample to the features.

In some embodiments, the composition to form the features includes, without limitation, one or more of a polymer, a liquid polymer, a solution, a monomer, a plurality of monomers, a polymerization initiator, a polymerization catalyst, an inorganic precursor, an organic material, a natural product, a metal precursor, a pharmaceutical agent, a tag, a magnetic material, a paramagnetic material, a ligand, a cell penetrating peptide, a porogen, a surfactant, a plurality of immiscible liquids, a solvent, a charged species, combinations thereof, or the like. In some embodiments, the monomer includes butadienes, styrenes, propene, acrylates, methacrylates, vinyl ketones, vinyl esters, vinyl acetates, vinyl chlorides, vinyl fluorides, vinyl ethers, acrylonitrile, methacrylnitrile, acrylamide, methacrylamide allyl acetates, fumarates, maleates, ethylenes, propylenes, tetrafluoroethylene, ethers, isobutylene, fumaronitrile, vinyl alcohols, acrylic acids, amides, carbohydrates, esters, urethanes, siloxanes, formaldehyde, phenol, urea, melamine, isoprene, isocyanates, epoxides, bisphenol A, alcohols, chlorosilanes, dihalides, dienes, alkyl olefins, ketones, aldehydes, vinylidene chloride, anhydrides, saccharide, acetylenes, naphthalenes, pyridines, lactams, lactones, acetals, thiiranes, episutfide, peptides, derivatives thereof, and combinations thereof. In yet other embodiments, the polymer includes polyamides, proteins, polyesters, polystyrene, polyethers, polyketones, polysulfones, polyurethanes, polysiloxanes, polysilanes, cellulose, amylose, polyacetals, polyethylene, glycols, poly(acrylate)s, poly(methacrylate)s, poly(vinyl alcohol), poly(vinylidene chloride), poly(vinyl acetate), poly(ethylene glycol), polystyrene, polyisoprene, polyisobutylenes, poly(vinyl chloride), poly(propylene), poly(lactic acid), polyisocyanates, polycarbonates, alkyds, phenolics, epoxy resins, polysulfides, polyimides, liquid crystal polymers, heterocyclic polymers, polypeptides, conducting polymers including polyacetylene, polyquinoline, polyaniline, polypyrrole, polythiophene, and poly(p-phenylene), dendimers, fluoropolymers, derivatives thereof, combinations thereof, and the like.

In some embodiments, the composition in the cavities is cured or hardened. In certain embodiments, the composition may be cured or hardened by heat or evaporation; cured by actinic radiation, thermal curing, or other such curing techniques; combinations thereof; or the like. In some embodiments, the composition may form a particle within the cavity.

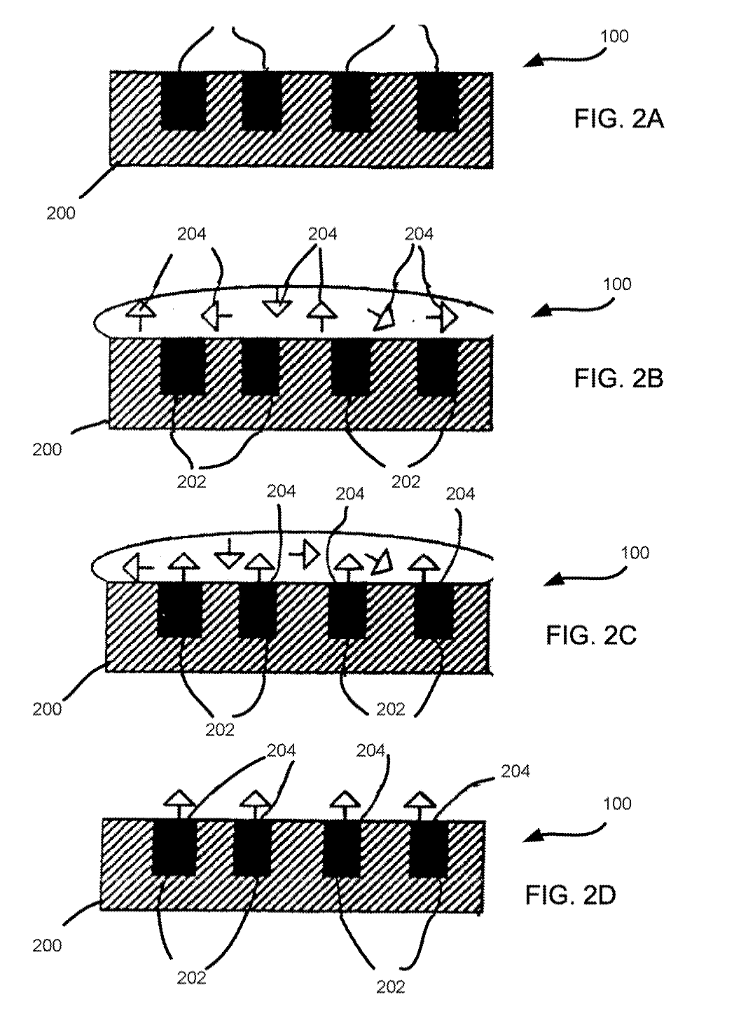

According to an embodiment, after a nanoarray is fabricated, cavities 110 of the nanoarray are filled or partially filled with a precursor composition 202, as shown for example in FIG. 2. In some embodiments, cavities 110 of nanoarray 200 are filled by placing a patterned side of the nanoarray 200 down into a precursor composition 202. In some embodiments, nanoarray 200 is then left in the precursor composition for about 2 minutes before nanoarray 200 is removed from the precursor composition. Upon removal of nanoarray 200 from precursor composition 202, cavities 110 of nanoarray 200 are filled with precursor composition 202. In some embodiments, the precursor composition 202 is drawn across nanoarray 200, leaving cavities 110 of nanoarray 200 filled with precursor composition 202. Other methods and systems for cavities 110 of nanoarray 200 are disclosed in the documents cited herein and incorporated herein by reference and will be appreciated by one of ordinary skill in the art to be equally applicable in the present invention.

In some embodiments, nanoarray 200 is pulled vertically and slowly from the precursor composition, allowing the precursor solution to dewet off the surface of nanoarray 200 as nanoarray 200 is removed. Next, nanoarray 200 can be, in some embodiments where precursor composition includes a photo curing agent, purged under nitrogen for about 2 minutes and treated with a light source, such as treatment under a 365 nm light, to activate and cure precursor composition 202. In other embodiments, after precursor composition 202 is filled into the cavities 110 of nanoarray 200, the precursor composition can be used in a liquid or semi-liquid form; hardened by treating the composition with a treatment, such as for example, heat or evaporation; cured by actinic radiation, thermal curing, or other such curing techniques; combinations thereof; or the like.

In some embodiments, cavities 110 of the nanoarray are partially filled with a precursor composition 202. In some embodiments, cavities 110 of nanoarray 200 are filled with precursor composition 202 to a level lower than land area L.

Particle Features

In some embodiments, a feature may include a discrete particle. In certain embodiments, the particles may have a predetermined size and/or shape. According to some embodiments, the plurality of particles may have a substantially uniform size and/or shape. In some embodiments, the particles are microparticles. In other embodiments, the particles are nanoparticles. In some embodiments, a particle has a broadest linear dimension of 5 micrometers. In some embodiment, a particle has a broadest linear dimension of less than about 2 micrometers. In some embodiment, a particle has a broadest linear dimension of less than about 1 micrometer. In some embodiments, a particle has a broadest linear dimension of less than about 750 nanometers. In some embodiments, a particle has a broadest linear dimension of less than about 500 nanometers. In some embodiments, a particle has a broadest linear dimension of less than about 250 nanometers. In some embodiments, a particle has a broadest linear dimension of less than about 200 nanometers. In some embodiments, a particle has a broadest linear dimension of less than about 100 nanometers. In some embodiments, a particle has a broadest linear dimension of less than about 50 nanometers. In some embodiments, a particle has a broadest linear dimension of less than about 25 nanometers.

In some embodiments, a surface includes a plurality of particles. In such embodiments, the particles may be arranged on the surface in a predetermined array as discussed herein. In some embodiments, the particles may be coupled to the surface.

In some embodiments, composition 202 can be treated while in cavities 110 to form particles 302. Particles 302 can be fabricated in cavities 110 by hardening composition 202, evaporating a solvent from composition 202, curing composition 202, such as photo-curing or thermal curing, combinations thereof, or the like. According to other embodiments, particles 302 can be fabricated from nanoarrays 200 as described in references cited herein and incorporated herein by reference.

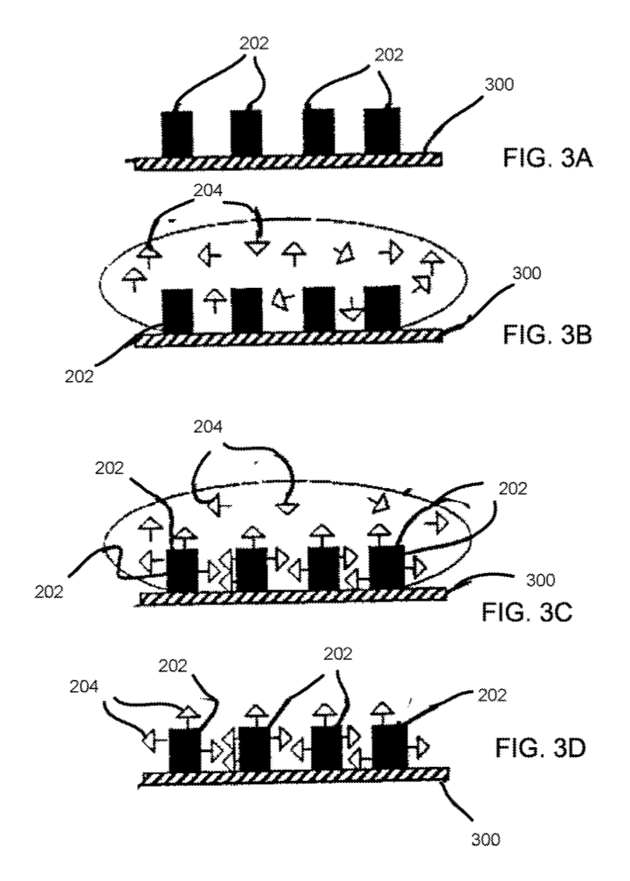

After particles 302 have been formed from composition 202 in cavities 110, particles 302 can be subsequently harvested or removed from cavities 110. In some embodiments, particles 302 can be harvested onto sheet 300, as shown in FIG. 3A-3D. In certain embodiments, the array of particles 302 on sheet 300 may, mimic the array of cavities 110. Particles 302 can be harvested from nanoarray 200 using, for example, methods described herein and/or in the references cited herein and incorporated herein by reference. In some embodiments, particles 302 may mime the size and shape of cavities 110.

In some embodiments, particles may be released from the substrate after harvesting to form isolated independent features that can be introduced into a sample, rather than introducing a sample to the features in a nanoarray.

Linker Groups

According to some embodiments, a feature may include a linker group. A linker group may be configured to bind with at least one probe or link a probe to the feature.

In some embodiments, precursor composition 202 can include a linker group. In some embodiments, the linker group can chemically or physically bind with composition 202 and in other embodiments, the linker group can simply be dispersed in composition 202. In some embodiments, the linker group may be coupled with a surface of a feature. In certain embodiments, the linker group provides functionality to composition 202 such that other agents, such as probes or modifying agents, can chemically or physically interact with composition 202 or with a surface of composition 202. In some embodiments the linker group includes, but is not limited to one or more of sulfides, amines, amides, carboxylic acids, acid chlorides, alcohols, alkenes, alkyl halides, isocyanates, imidazoles, halides, azides, acetylenes, combinations thereof, or similar groups that can link to biologic molecules, non-biologic molecules, organic molecules, drug development or delivery agents, and the like.

Probes

In some embodiments, features of the present invention include a probe. In some embodiments, a feature may include more than one probe. In some embodiments, a feature includes more than one type of probe. In certain embodiments, an array may include at least one feature which includes a first probe and a second feature which includes a second probe which is different from the first probe.

According to some embodiments, the probe is associated with the feature by an interaction including but not limited to covalent interactions, chemical adsorption, hydrogen bonding, surface interpenetration, ionic bonding, van der Waals forces, hydrophobic interactions, magnetic interactions, dipole-dipole interactions, and mechanical interlocking. In some embodiments, a probe is configured for coupling with at least one target. In some embodiments, a feature demonstrates an affinity to a target without use of a probe.

In certain embodiments of the present invention, probe or group 204 is introduced to the combination of composition 202 and the linker group. In some embodiments probe 204 chemically attaches to the particle or feature through the linking group. In other embodiments, probe 204 couples to the particle or feature without a linking group. In some embodiments, a feature demonstrates an affinity to a target without use of probe 204. In some embodiments, probe 204 includes a target sample or is complimentary to a target sample. In certain embodiments, probe 204 includes a biomolecule, that is labeled with radioactive isotopes or with a fluorescent marker, that can selectively bind to a specific gene or nucleic acid sequence for isolation or identification. In one embodiment, probe 204 includes a strand of nucleic acid which can be labeled and used to hybridize to a complementary sequence from a mixture of other nucleic acids. In another embodiment, probe 204 includes, without limitation, one or more of dyes, fluorescence tags, radiolabeled tags, contrast agents, ligands, peptides, antibodies or fragments thereof, pharmaceutical agents, aptamers, pharmaceutical agents, proteins, DNA, RNA, siRNA, RNAi, biologic molecules, non-biologic molecules, organic compositions, cells, combinations thereof, or the like.

In one embodiment, the precursor composition 202 can be substantially a polyethylene glycol (PEG) based composition having a linker group dispersed therein such that probe 204 can attach, through the linker group, to the composition 202, as shown in. FIGS. 2-7.

In other embodiments, linker group, probe, and compositions can be selected from any such linker composition or molecule described herein, described in references incorporated herein by: reference, or generally known in the art for assembling microarrays such as, but not limited to the microarrays and probe molecules generally disclosed in Barbulovic-Nad, I., et al., Bio-Microarray Fabrication Techcniques—A Review, Critical Reviews in Biotechnology, 26:237-259, 2006; Stoughton R., Applications of DNA Microarrays in Biology, Annu. Rev. Biochem. 74:53-82 2005; Heller M. J., DNA Microarray Technology Devices, Systems, and Applications, Annu. Rev. Biomed. Eng. 4:129-153 2002; U.S. Patent Publication no. 2004/0028804; and U.S. Patent Publication no. 2005/0064209; each of which is incorporated herein by reference in its entirety.

In some embodiments, precursor composition 202 can include a probe within its composition. In other embodiments, after precursor composition 202 is filled into cavities 110, probe 204 can be introduced to nanoarray 200/precursor composition 202 combination and allowed to associate to the precursor solution. In some embodiments, probe 204 is introduced to nanoarray 200/precursor composition 202 combination in a solution and allowed to freely associate with a surface of composition 202 as shown in FIGS. 2B and 2C. In some embodiments, probe 204 is introduced to nanoarray 200/precursor composition 202 combination in a solution and chemically binds with the surface of composition 202 due to the presence of a linking group. In some embodiments, the chemical binding between modifying group 204 and composition 202 and/or the linker group includes, but is not limited to, covalent binding, ionic bonding, other intra- and inter-molecular forces, hydrogen bonding, van der Waals forces, combinations thereof, and the like. In some embodiments, probe 204 is built onto nanoarray 200 at feature locations by sequentially adding subunits of probe 204, such as nucleotides for example, and attaching them thereto. In some embodiments, each feature site of each nanoarray 200 has a different probe built thereon and attached thereto. Therefore, a single nanoarray 200 provides a variety of probes for binding different targets in a sample.

Due to the chemical and physical characteristics of the materials disclosed herein for fabrication of nanoarray 200, the probe 204 does not chemically or physically associate with land area L (FIG. 1) between composition spot or feature 202. Thereby, each composition spot 202 forms a functionalized, discrete, highly ordered, high density, nanoarray, as shown in FIG. 2D. In other embodiments, probe 204 can be built onto composition 202 of nanoarray 200 according to typical methods in the art such as, but not limited to photolithography, inkjetting, and the like. According to other embodiments, because the processing steps for fabricating composition 202 in cavities 110 of nanoarray 200 can include delicate procedures, for example, room temperature operations, lack of chemical applications such as strongly acidic or basic solutions, atmospheric pressures, and the like, probe 204 can be combined with the particle precursor materials before they are introduced into cavities 110 of nanoarray 200.

As described herein, composition 202 can be treated while in cavities 110 to form particles 302. Particles 302 may then be harvested from cavities 110. Following harvesting, particles 302 can be introduced to probe 204. Similar to other embodiments disclosed herein, probe 204 can associate with particles 302 either chemically or physically and can be any appropriate probe 204. However, functionalizing particles 302 with probe 204 after particles 302 have been harvested from nanoarray 200 can yield an increased association of probe 204 with particle 302. In some embodiments, the increased association results from a larger exposed surface area of particle 302 after being harvested from nanoarray 200.

Masking

In some embodiments, a masking technique may be employed in fabricating nanoarrays of the present invention. In some embodiments, a masking technique may allow selective introduction of compositions to mold cavities or selective sequential introduction of probe subunits for building the probes thereon. According to some embodiments, during introduction of a composition to the cavities, a mask may be employed to cover selected cavities, thereby allowing introduction of the composition to the exposed cavities while blocking the composition from entering the masked or covered cavities. In some embodiments, a mask may then be employed in the same manner to introduce a different composition to cavities which masked in the first step.

In some embodiments, a masking technique may be used to selectively introduce probes or targets to the features of the present invention. In some embodiments, during introduction of a probe or target sample to the features, a mask may be employed to cover selected features, thereby allowing introduction of the probe or target sample to the exposed features while blocking the probe or target sample from entering the masked or covered features.

Multiple Molds

According to some embodiments, a nanoarray may include multiple molds. In some embodiments, a first mold is fabricated having a plurality of cavities as described herein. A second mold having a plurality of cavities may be fabricated, and positioned adjacent the first mold. In one embodiment, the second mold is positioned adjacent the first mold and within less than 5 micrometers. In another embodiment, the second mold is positioned adjacent the first mold and within less than 2 micrometers. In another embodiment, the second mold is positioned adjacent the first mold and within less than 1 micrometer. In another embodiment, the second mold is positioned adjacent the first mold and within less than 750 nanometers. In another embodiment, the second mold is positioned adjacent the first mold and within less than 500 nanometers. In another embodiment the second mold is positioned adjacent the first mold and within less than 250 nanometers. In another embodiment, the second mold is positioned adjacent the first mold and within less than 200 nanometers. In another embodiment, the second mold is positioned adjacent the first mold and within less than 150 nanometers. In another embodiment the second mold is positioned adjacent the first mold and within less than 100 nanometers. In another embodiment, the second mold is positioned adjacent the first mold and within less than 50 nanometers. In another embodiment, the second mold is positioned adjacent the first mold and within less than 25 nanometers.

IV. Use of Nanoarrays to Identify a Target

According to some embodiments, a nanoarray of the present invention may be used to identify a target in a sample. In some embodiments, a sample including one or more targets may be contacted with a nanoarray. Targets can include, but are not limited to, a nucleotide sequence, polynucleotide, genes, gene products, proteins, peptide, toxins, antigens, antibodies, lipids, saccharides, organic molecules, portions thereof, combinations thereof, or the like. In certain embodiments, a target may have an affinity to a probe, particle, and/or composition in the array and may bind with that probe, particle, and/or composition. In some embodiments, the features associated with the target-bound probes are detected and cross-referenced with a library of what probe is associated with the feature in order to determine the identity of the target.

In some embodiments, a sample is contacted with a nanoarray including a surface with a plurality of cavities including a composition. In some embodiments, a sample is contacted with a nanoarray including a surface with a plurality of particles. In other embodiments, a sample is contacted with a plurality of discrete particles.

As described herein, in some embodiments composition 202 can be treated while in cavities 110 to form particles 302. After particles 302 have been formed from composition 202 in cavities 110, particles 302 can be subsequently harvested or removed from cavities 110. In some embodiments, particles 302 can be harvested onto sheet 300, as shown in FIG. 3A-3D. Following harvesting, particles 302 can be introduced to probe 204. Similar to other embodiments disclosed herein, probe 204 can associate with particles 302 either chemically or physically and can be any appropriate probe 204. However, functionalizing particles 302 with probe 204 after particles 302 have been harvested from nanoarray 200 can yield an increased association of probe 204 with particle 302. In some embodiments, the increased association results from a larger exposed surface area of particle 302 after being harvested from nanoarray 200. Thus, when functionalized particle 302/probe 204 are used for applications such as traditional microarray application including detecting analytes, binding antigens or antibodies, building or binding oligonucleotides, protein detection, and the like, there is an increased chance of an intended target binding to probe 204. Furthermore, following probe 204 binding its intended target, a signal to noise ratio for detecting target binding is increased when the particle 302 has an increased number of target binding probe 204. In other embodiments, nanoarray 200 can be enhanced to further increase a signal to noise ration or to detect targets on particles 302 by such techniques as, but not limited to, coating nanoarray 200 with a metal, such as for example a layer of gold.

In further embodiments, cavities 110 of nanoarray 200 can replicate virtually any shape that a master template can be fabricated, such as but not limited to etched or engraved master templates. Accordingly, the shape and size of cavity 110 can be reproduced in the particle 302. Therefore, the methods and materials of the present invention provide a new dimension to diagnostics and identification of target samples. According to some embodiments, multiple nanoarrays can be fabricated, each having a unique shape and/or size particle fabricated therefrom. Next, all the multiple shape and/or size particles fabricated from the multiple nanoarrays can be tested on a particular sample in a single given test. Then, all the particles can be analyzed, in a single step. By knowing which shape particles are associated with what probes or sample fragments, particles identified as binding to targets can be differentiated based on shape and/or size, thereby identifying the target. In other embodiments, particles can also include different chemical functionality groups or tags, such as for example, amine groups, sulfur groups, halogens, metals, other chemical tags, fluorescence, radioisotopes, and the like to further identify and differentiate between different particles.

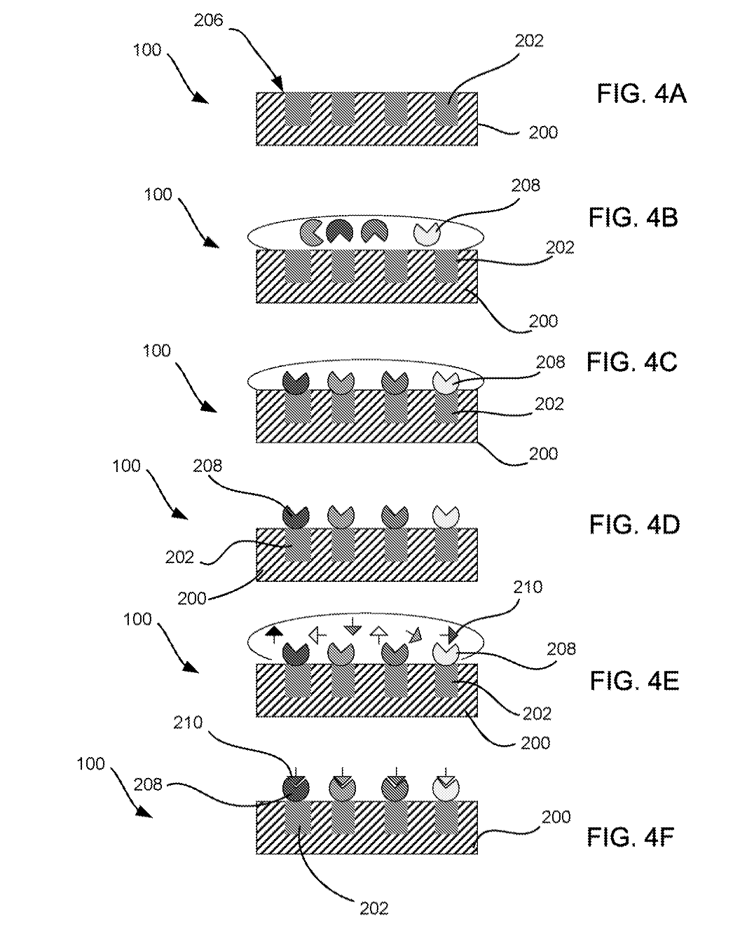

FIGS. 4A-4F shows another process for making a nanoarray having functionalized discrete particles. According to FIGS. 4A-4D, nanoarray 100 includes nanoarray 200 having cavities 110 that include, in alternative embodiments, precursor composition 202 or particle 302. In some embodiments, particle 302 includes a linking group that has affinity for a particular probe 208. It will be appreciated that particular linking groups and probes are generally known in the art and can be selected from known linking groups and probes for a given particular application. Next, as shown in FIGS. 4B, 4C, and 4D probe 208 can be introduced to nanoarray 100 and allowed to associate with linking group of precursor composition 202 or particle 302. Next, a sample to be analyzed, such as fragment 210 is introduced to the combination of nanoarray 100, precursor composition 202 or particle 302, and probe 208, as shown in FIG. 4E. Fragment 210 will then associate with an appropriate probe 208 and any excess can be washed away, leaving nanoarray 100 with a sample fragment 210 bound to probe 208, which is in turn linked to precursor composition 202 or particle 302, as shown in FIG. 4F.

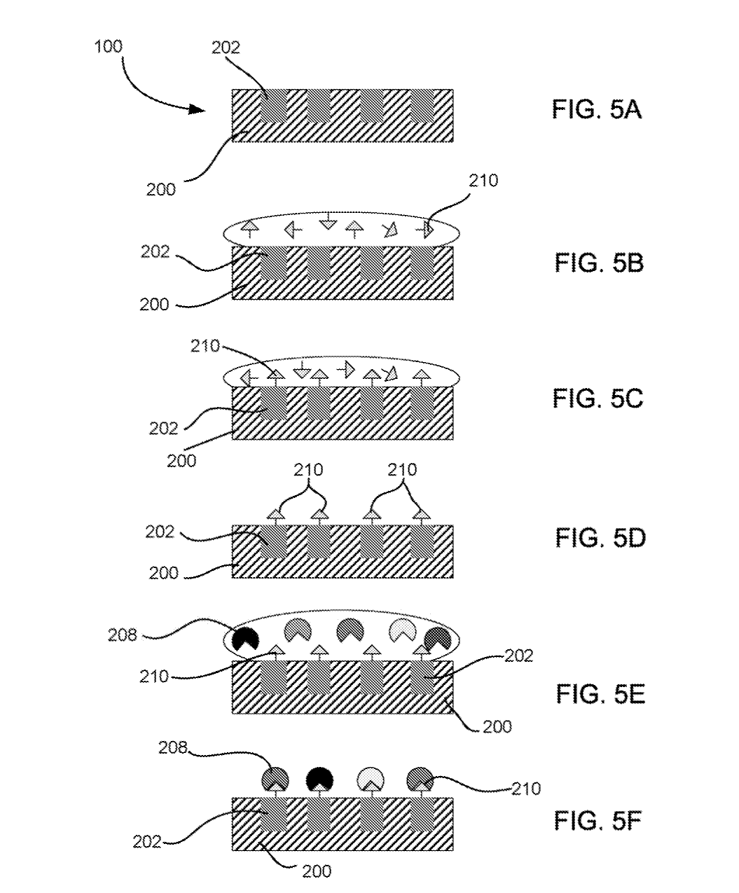

In other embodiments, such as shown in FIG. 5A-5F, a nanoarray 100 can be configured with a precursor composition 202 or particle 302 having a linking group that is configured to bind or associate with a sample to be analyzed. As shown in FIGS. 5B-5D, sample 210 is introduced to the nanoarray/functionalized precursor composition 202 or particle 302 and allowed to associate therewith. As described herein, due to the physical and chemical nature of the materials disclosed here for fabricating nanoarray 100, sample 210 will not adhere to the land area of nanoarray 100. Thereby, the precursor composition 202 or particle 302 become discrete, highly ordered, test spots. Next, a probe 208, for detecting a particular sample 210, is introduced to the combination and allowed to associate with any appropriate sample, if present, as shown in FIG. 5E-5F.

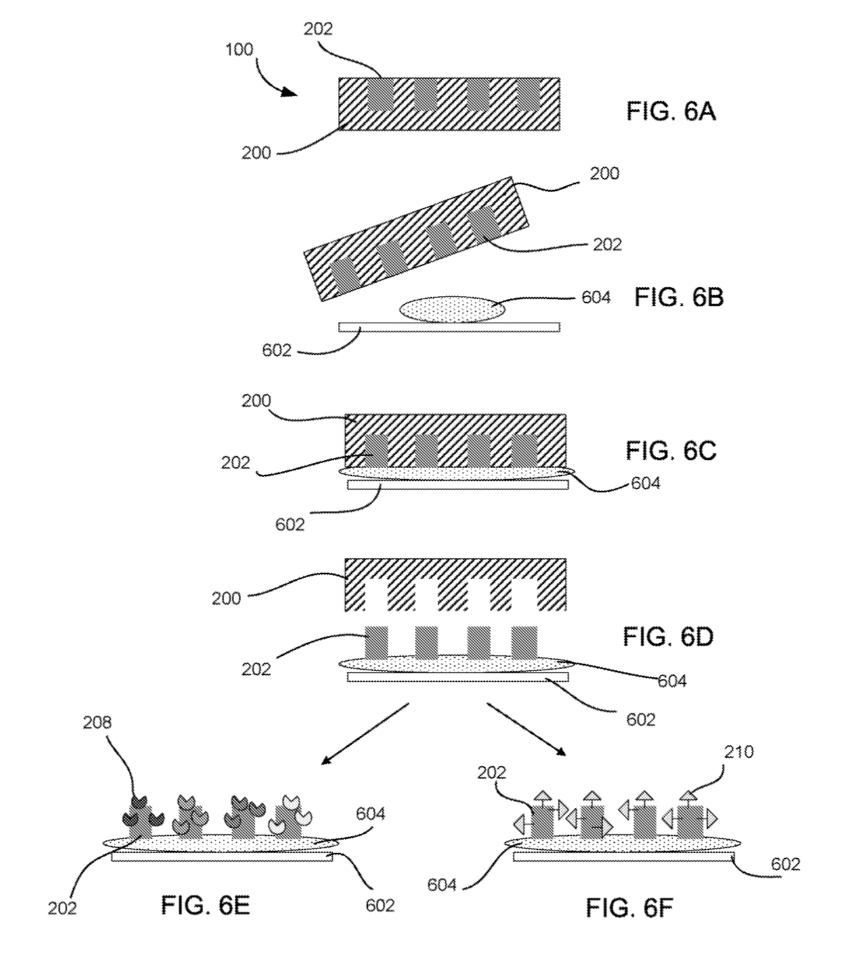

In alternative embodiments, as described herein and shown in FIGS. 6A-60, particles 302 can be harvested after being fabricated in nanoarray 200. According to such embodiments, particles 302 in nanoarray molds 200 can be introduced to harvesting material 604 on a backing 602, as shown in FIG. 68-60. Harvesting material 604 can include a liquid, gel, paste, film, or the like that has an affinity for particle 302 or a linking group/functionalizing group in particle 302. After nanoarray 200 is associated with backing 602 such that harvesting material 604 is communicated with particles 302, nanoarray 200 can be removed from backing 602 to provide harvested particles 302 on backing 602. Thereafter, harvested particles 302 can be associated with a probe 208 or a sample fragment 210, as disclosed herein and as shown in FIGS. 6E and 6F, respectively.

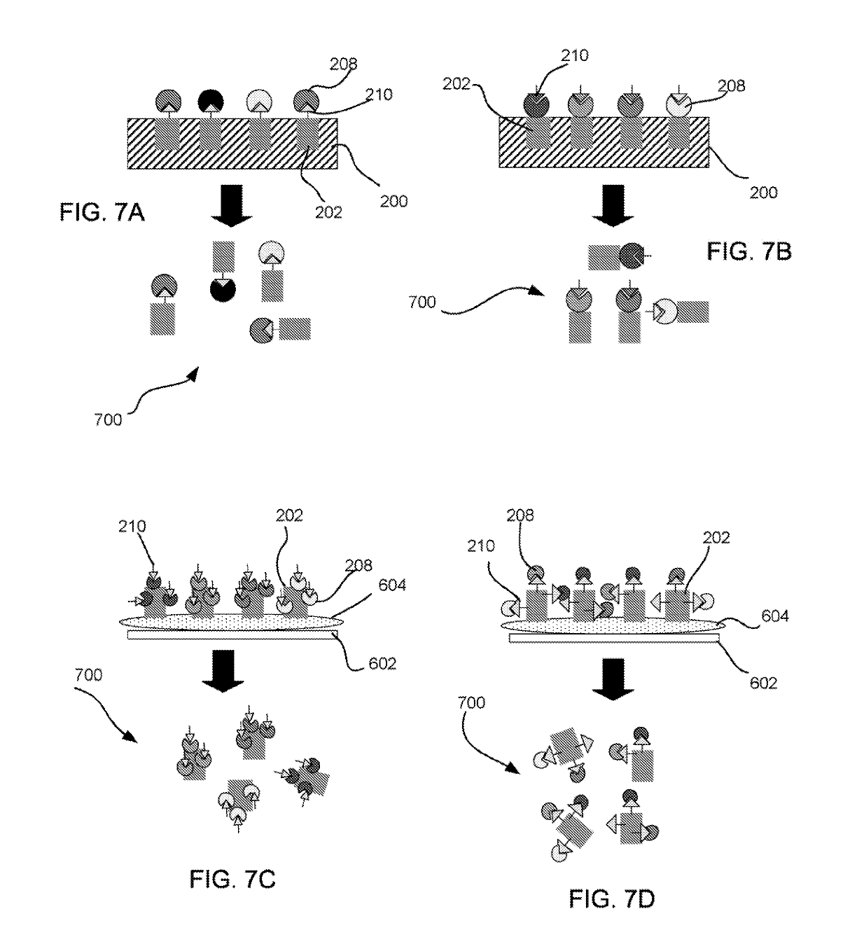

In alternative embodiments, as shown in FIGS. 7A-7D, particles 302 can be harvested from nanoarrays 200 prior to or following association with probe 208 and/or sample fragment 210 and analyzed as discrete particle complexes 700. Accordingly, particle complexes including particle 302, probe 208, and sample fragment 210, can be harvested from nanoarray molds, as shown in FIGS. 7A and 7B, or harvested from backing layer 602 and harvesting material 604, as shown in FIGS. 7C and 7D, to form discrete particle complexes 700.

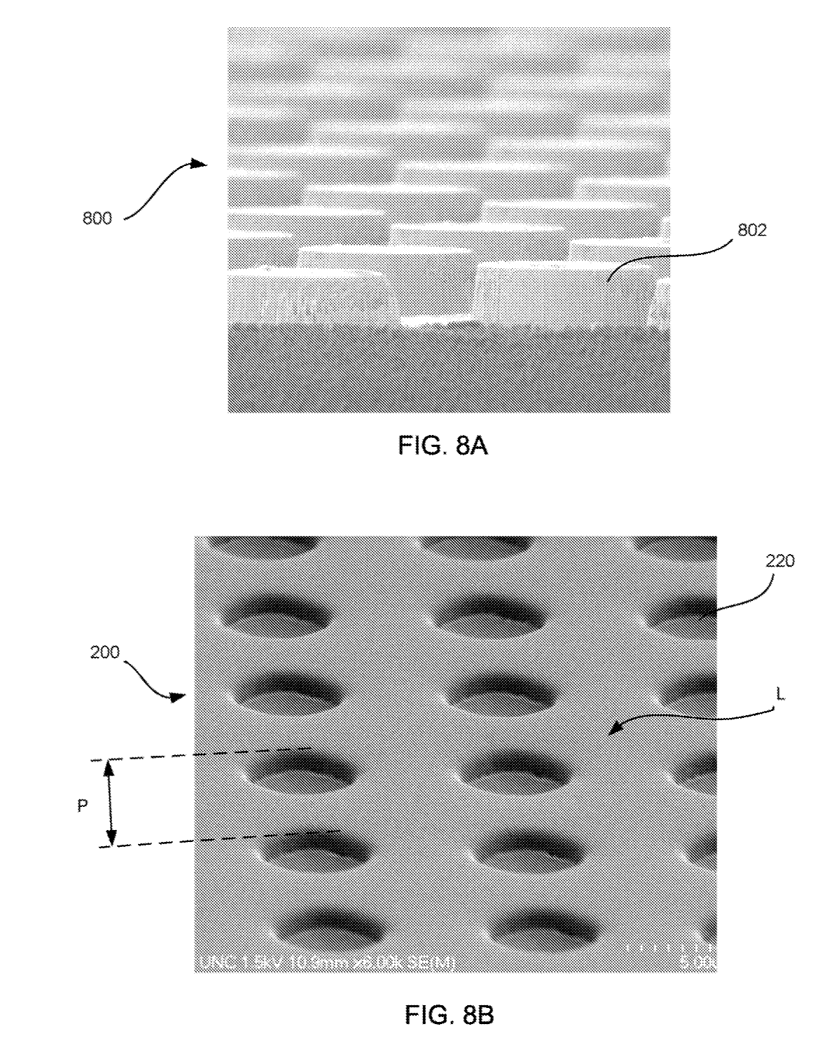

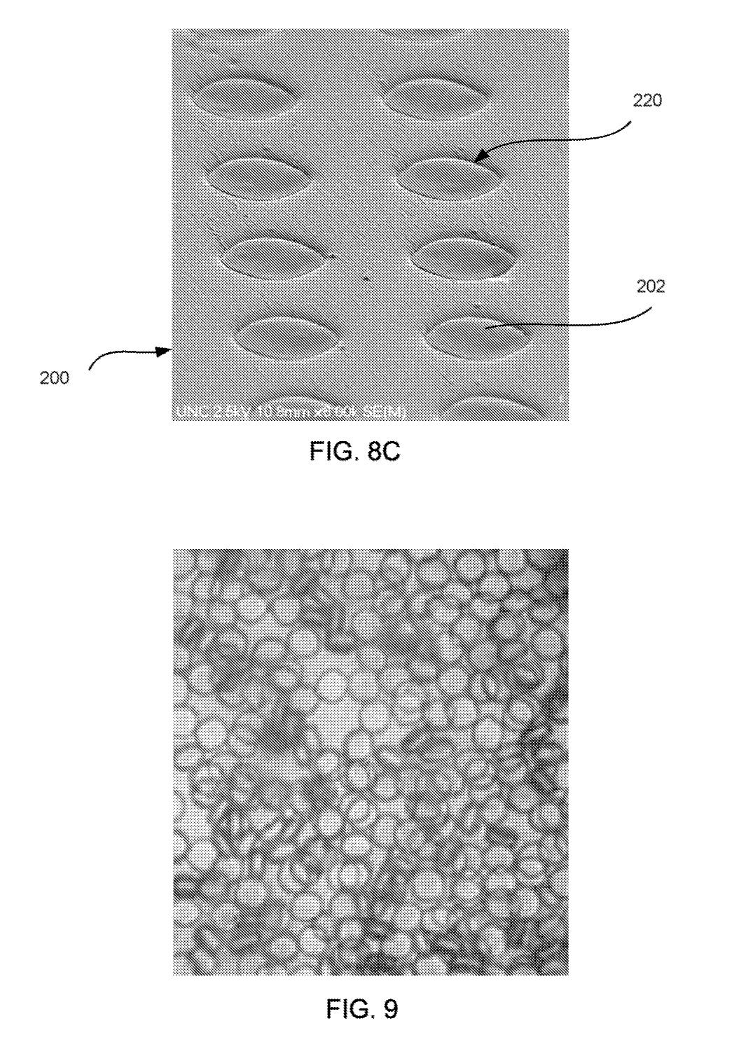

Referring now to FIGS. 8A-8C, scanning electron microscope figures of an etched master, unfilled nanoarray 200, and nanoarray cavities 110 filled with functionalized precursor composition 202 or particles 302 are shown. FIG. 8A shows an etched master 800 having structures 802. In some embodiments, etched master 800 can be an etched silicon wafer or the like. FIG. 8B shows a nanoarray 200 fabricated from the etched master 800 of FIG. 8A. Nanoarray 200 includes cavities 110 into which precursor composition 202 fills to form particles 302. FIG. 8C shows nanoarray 200 with particles 302 formed in cavities 110. FIG. 9 shows particles 302 after the particles have been harvested from cavities 110 of nanoarray 200.

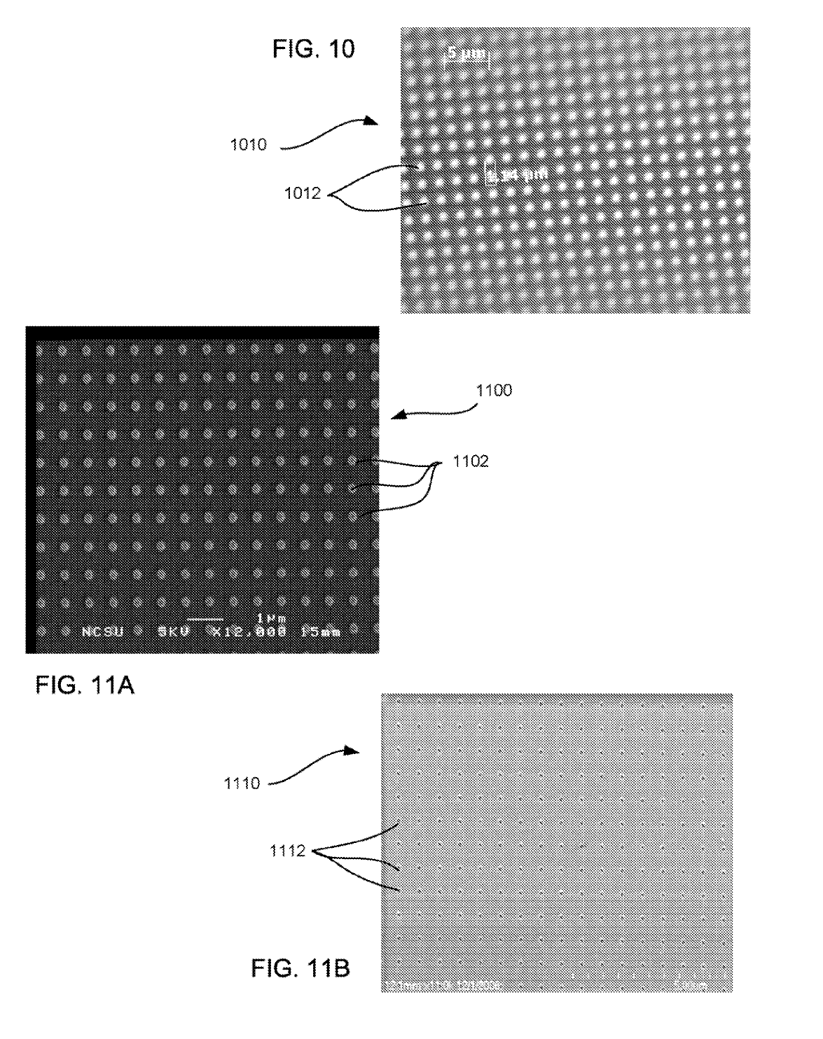

FIG. 10 shows a top view of a nanoarray 1010 having a plurality of particles 1012 fabricated within associated cavities. Referring now to FIG. 11A, a master patterned template 1100 is shown having 200 nm posts 1102 organized in an ordered array. FIG. 11B shows a nanoarray 1110 fabricated from master patterned template 1100, such that nanoarray 1110 includes replica 200 nm cavities 1112 mimicking 200 nm posts 1102 of master patterned template 1100.

According to some embodiments, the linker group 204 can include, but is not limited to a therapeutic or diagnostic agent coupled therewith. The therapeutic or diagnostic agent can be physically coupled or chemically coupled with the particle, encompassed within the particle, at least partially encompassed within the particle, coupled to the exterior of the particle, combinations thereof, and the like. The therapeutic agent or diagnostic can be a drug, a biologic, a ligand, an oligopeptide, a cancer treating agent, a viral treating agent, a bacterial treating agent, a fungal treating agent, combinations thereof, or the like.

In yet other embodiments, the particle can include a functional location such that the particle can be used as an analytical material. According to such embodiments, particles 202 include a functional molecular imprint. The functional molecular imprint can include functional monomers arranged as a negative image of a functional template. The functional template, for example, can be but is not limited to, chemically functional and size and shape equivalents of an enzyme, a protein, an antibiotic, an antigen, a nucleotide sequence, an amino acid, a drug, a biologic, nucleic acid, combinations thereof, or the like. In other embodiments, the particle itself, for example, can be, but is not limited to an artificial functional molecule. In one embodiment, the artificial functional molecule is a functionalized particle that has been molded from a molecular imprint. As such, a molecular imprint is generated in accordance with methods and materials of the presently disclosed subject matter and then a particle is formed from the molecular imprint, in accordance with further methods and materials of the presently disclosed subject matter. Such an artificial functional molecule includes substantially similar steric and chemical properties of a molecular imprint template. In one embodiment the functional monomers of the functionalized particle are arranged substantially as a negative image of functional groups of the molecular imprint.

According to some embodiments, tracers, radiotracers, and/or radiopharmaceuticals are the material of the particle or can be included with the particles. In some embodiments, one or more particles contain chemical moiety handles for the attachment of protein. In some embodiments, the protein is avidin. In some embodiments biotinylated reagents are subsequently bound to the avidin. In some embodiments the protein is a cell penetrating protein. In some embodiments, the protein is an antibody fragment. In one embodiment, the particles or features can be used for specific targeting, (e.g., breast tumors in female subjects). In some embodiments, the particles or features can contain therapeutics for interacting with a target. In some embodiments, the particles are composed of a cross link density or mesh density designed to allow controlled release of the therapeutics prior to, during, or after binding of a target. The term crosslink density means the mole fraction of prepolymer units that are crosslink points. Prepolymer units include monomers, macromonomers and the like.

According to some embodiments, nanoarrays can be used to measure gene expression levels, such as expression profiling and the like. In other embodiments, nanoarrays can be used for genotyping or detecting subtle sequence variations; disease diagnosis and evaluation; pathogen detection and characterization (e.g. detecting genomic DNA from microbes); drug development; protein-protein and protein-ligand interactions for evaluating and diagnosing disease susceptibility and progression; other molecular interactions, such as for example DNA-protein interactions; discovering potential therapeutic targets faster and more accurately than present techniques; protein expression from cell lysates; special biomarkers in serum or urine for diagnostics applications; functional response patterns; pathology; cancer research and diagnostics; environmental health; addictions; personalized medicine; genetic identification, such as forensics; combinations thereof, and the like.

In some embodiments, detection of particles bound with a target can include techniques such as fluorescent; chemiluminescent; spectroscopy; colorimetric; radioisotope; mass spectrometry; infrared; near-IR; surface plasmon resonance; electronic detection; combinations thereof, and the like. Further detection, masking, and characteristics of making a nanoarray are disclosed in U.S. Pat. No. 6,416,952, which is incorporated herein by reference in its entirety.

V. Use of Nanoarrays to Grow Cells

In some embodiments, a nanoarray of the present invention is used to retain and grow cells, as described in more detail in Mordechai Deutsch et al. “A Novel Miniature Cell Retainer for Correlative High-Content Analysis of Individual Untethered Non-Adherent Cell,” Lab Chip, Vol. 6 (2006) pp. 995-1000, which is hereby incorporated by reference in its entirety. In research relating to the living cell, it is desired important to preserve individual cell identity within a cell population. In some embodiments, cell locations may be controlled by a plurality of cavities of a nanoarray of the present invention. In some embodiments, a small distance between adjacent cavities encourages cells to settle within the cavities rather than on the surface between cavities.

In some embodiments, a cavity of a nanoarray of the present invention may hold a single cell. In other embodiments, a cavity of a nanoarray of the present invention may hold multiple cells. According to some embodiments, a nanoarray may be used to control the number of cell replication cycles based on the cell to cavity size ratio. In some embodiments, a cell may be grown in a cavity filled with various media, drugs, treatments, combinations thereof, or the like.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### PFPE-Based Microarrays with Spot Size of 200 nm, 1 μm, and 3 μm

A solution of 2,2-diethoxyacetophenone, ethanol, polyethylene glycol diacrylate (PEG) (MW 400), and 2-aminoethyl methacrylate hydrochloride (AMH) was made as follows. The target amount of PEG needed was weighed (10 g). 10 wt % AMH (1 g) relative to target weight of PEG was weighed out in a separate vial. Enough ethanol to dissolve the AMH was added, and the total weight was noted (typically 10-50% solution by volume). The target amount of PEG is then added to the vial, along with 0.1 wt % 2,2-diethoxyacetophenone, relative to PEG. The sample was placed sample in vacuum chamber for ˜1 hr. The vial was then re-weighed to check ethanol removal, with the goal of removing ˜90% of ethanol. The solution was then filtered through a 0.2 um syringe filter.

The PFPE nanoarray was made from a silicon master patterned with the desired spot size and shape as follows: 3 silicon masters having varying sized post features: (1) 200 nm posts with 700 nm pitch (2) 1 μm posts with 2 μm pitch (3) 3 μm posts with 6 μm pitch were cleaned with IPA. 10-15 mL of PFPE-DMA containing 3% photoinitiator were cast over the wafer and the wafer was purged under nitrogen for 2 minutes, Followed by curing for 2 minutes under 365 nm, light. We then cut nanoarray into pieces of required array size.

The cavities of the nanoarray were then filled with the spot solution through the following procedure: place patterned side of the nanoarray down in solution, one at a time, and leave for ˜2 minutes. Pull the sample out of solution vertically and slowly, allowing solution to dewet off the surface as you go. You will be able to observe this phenomenon as you go. Purge the filled nanoarray under nitrogen for 2 minutes, and cure 2 minutes under 365 nm, light. Arrays made by this method are shown in FIGS. 10, 11a and 11b

### Example 2

### Fabrication of a Perfluoropolyether-dimethacrylate (PFPE-DMA) Mold from a Template Generated Using Photolithography

A template, or “master,” for perfluoropolyether-dimethacrylate (PFPE-DMA) mold fabrication is generated using photolithography by spin coating a film of SU-8 photoresist onto a silicon wafer. This resist is baked on a hotplate at 95° C. and exposed through a pre-patterned photomask. The wafer is baked again at 95° C. and developed using a commercial developer solution to remove unexposed SU-8 resist. The resulting patterned surface is fully cured at 175° C. This master can be used to template a patterned mold by pouring PFPE-DMA containing 1-hydroxycyclohexyl phenyl ketone over the patterned area of the master. A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the master, and can be imaged by optical microscopy to reveal the patterned PFPE-DMA mold.

### Example 3

### Encapsulation of Fluorescently Tagged DNA Inside 200-nm Trapezoidal PEG Particles

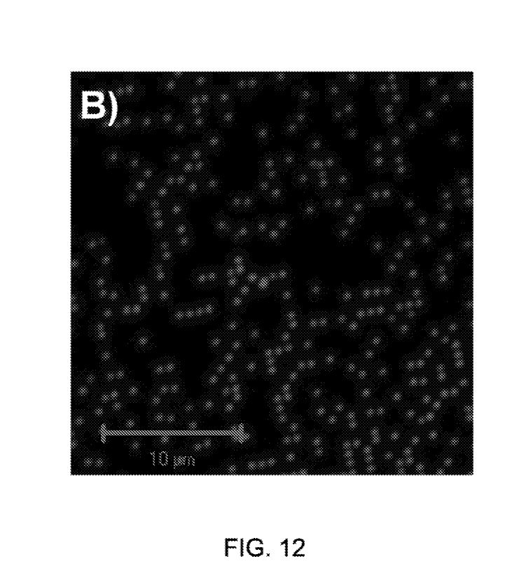

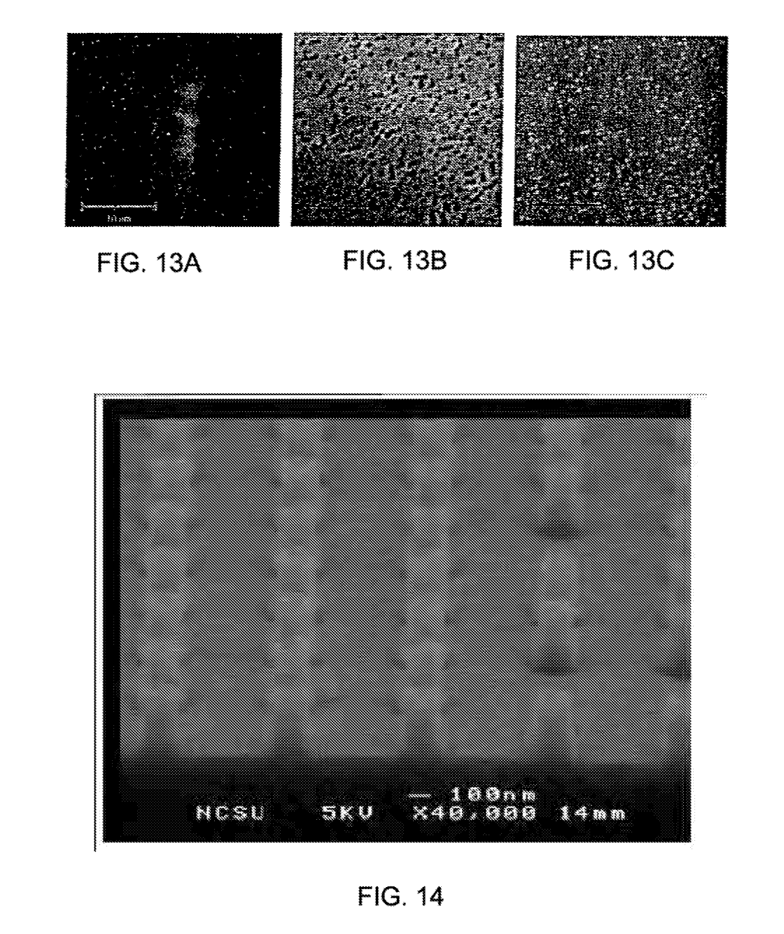

A patterned perfluoropolyether (PFPE) mold is generated by pouring a PFPE-dimethacrylate (PFPE-DMA) containing 1-hydroxycyclohexyl phenyl ketone over a silicon substrate patterned with 200-nm trapezoidal shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released film the silicon master. Separately, a poly(ethylene glycol) (PEG) diacrylate (n=9) is blended with 1 wt % of a photoinitiator, 1-hydroxycydohexyl phenyl ketone. 20 μL of water and 20 μL of PEG diacrylate monomer are added to 8 nanomoles of 24 by DNA oligonucleotide that has been tagged with a fluorescent dye, CY-3. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl)silane via vapor deposition in a desiccator for 20 minutes. Following this 50 μL of the PEG diacrylate solution is then placed on the treated silicon wafer and the patterned PFPE mold placed on top of it. The substrate is then placed in a molding apparatus and a small pressure is applied to push out excess PEG-diacrylate solution. The entire apparatus is then subjected to UV light (A=365 nm) for ten minutes while under a nitrogen purge. Particles are observed in an array after separation of the PFPE mold and the treated silicon wafer using confocal fluorescence microscopy. The particles are rinsed off the surface into solution (see FIG. 13). Further, FIG. 13A shows a fluorescent confocal micrograph of 200-nm trapezoidal PEG nanoparticles, which contain 24-mer DNA strands that are tagged with CY-3. FIG. 13B is optical micrograph of the 200-nm isolated trapezoidal particles of PEG diacrylate that contain fluorescently tagged DNA. FIG. 13C is the overlay of the images provided in FIGS. 13A and 13B, showing that every particle contains DNA.

### Example 4

### Encapsulation of Proteins in PEG-diacrylate Nanoparticles in a Mold

A patterned perfluoropolyether (PFPE) mold is generated by pouring PFPE-dimethacrylate (PFPE-DMA) containing 1-hydroxycydohexyl phenyl ketone over a silicon substrate patterned with 200-nm trapezoidal shapes (see FIG. 12). A poly(dimethylsiloxane) mold is used to confine the liquid PFPE-DMA to the desired area. The apparatus is then subjected to UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycydohexyl phenyl ketone. Fluorescently-labeled or unlabeled protein solutions are added to this PEG-diacrylate monomer solution and mixed thoroughly. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Following this 50 μL of the PEG diacrylate/virus solution is then placed on the treated silicon wafer and the patterned PFPE mold placed on top of it. The substrate is then placed in a molding apparatus and a small pressure is applied to push out excess PEG-diacrylate solution. The entire apparatus is then subjected to UV light (λ=365 nm) for ten minutes while under a nitrogen purge. Protein-containing particles are observed after separation of the PFPE mold and the treated silicon wafer using traditional assay methods or in the case of fluorescently-labeled proteins, confocal fluorescence microscopy.

### Example 5

### Harvesting of PEG Particles in an Array with Vinyl Pyrrolidone

A patterned perfluoropolyether (PFPE) mold is generated by pouring a PFPE-dimethacrylate (PFPE-DMA) containing 1-hydroxycyclohexyl phenyl ketone over a silicon substrate patterned with 5-μm cylinder shapes. The substrate is then subjected to a nitrogen purge for 10 minutes, and then UV light (λ=365 nm) is applied for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by coating a glass slide with PFPE-DMA containing 1-hydroxycydohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of PEG diacrylate is then placed on the flat PFPE-DMA substrate and the patterned PFPE mold placed on top of it. The substrate is then placed in a molding apparatus and a small pressure is applied to push out excess PEG-diacrylate. The entire apparatus is then purged with nitrogen for 10 minutes, then subjected to UV light (λ=365 nm) for 10 minutes while under a nitrogen purge. PEG particles are observed after separation of the PFPE-DMA mold and substrate using optical microscopy. A thin film of n-vinyl-2-pyrrolidone containing 5% photoinitiator, 1-hydroxycyclohexyl phenyl ketone, is placed on a clean glass slide. The PFPE-DMA mold containing particles is placed patterned side down on the n-vinyl-2-pyrrolidone film. The slide is subjected to a nitrogen purge for 5 minutes, then UV light (λ=365 nm) is applied for 5 minutes while under a nitrogen purge. The slide is removed, and the mold is peeled away from the polyvinyl pyrrolidone and particles. Particles in an array on the polyvinyl pyrrolidone were observed with optical microscopy. The polyvinyl pyrrolidone film containing particles was dissolved in water. Dialysis was used to remove the polyvinyl pyrrolidone, leaving an aqueous solution containing 5 μm PEG particles.

### Example 6

### Harvesting of PEG Particles onto an Array with Polyvinyl Alcohol

A patterned perfluoropolyether (PFPE) mold is generated by pouring a PFPE-dimethacrylate (PFPE-DMA) containing 1-hydroxycyclohexyl phenyl ketone over a silicon substrate patterned with 5-μm cylinder shapes. The substrate is then subjected to a nitrogen purge for 10 minutes, then UV light (λ=365 nm) is applied for 10 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 1-hydroxycyclohexyl phenyl ketone. Flat, uniform, non-wetting surfaces are generated by coating a glass slide with PFPE-DMA containing 1-hydroxycyclohexyl phenyl ketone. The slide is then subjected to a nitrogen purge for 10 minutes, then UV light (λ=365 nm) is applied for 10 minutes while under a nitrogen purge. The flat, fully cured PFPE-DMA substrate is released from the slide. Following this, 0.1 mL of PEG diacrylate is then placed on the flat PFPE-DMA substrate and the patterned PFPE mold placed on top of it. The substrate is then placed in a molding apparatus and a small pressure is applied to push out excess PEG-diacrylate. The entire apparatus is then purged with nitrogen for 10 minutes, then subjected to UV light (A=365 nm) for 10 minutes while under a nitrogen purge. PEG particles are observed after separation of the PFPE-DMA mold and substrate using optical microscopy. Separately, a solution of 5 weight percent polyvinyl alcohol (PVOH) in ethanol (EtOH) is prepared. The solution is spin coated on a glass slide and allowed to dry. The PFPE-DMA mold containing particles is placed patterned side down on the glass slide and pressure is applied. The mold is then peeled away from the PVOH and particles. Particles in an array on the PVOH were observed with optical microscopy. The PVOH film containing particles was dissolved in water. Dialysis was used to remove the PVOH, leaving an aqueous solution containing 5 μm PEG particles.

### Example 7

### Functionalizing PEG particles with FITC

Poly(ethylene glycol) (PEG) particles with 5 weight percent aminoethyl methacrylate were created. Particles are observed in the PFPE mold after separation of the PFPE mold and the PFPE substrate using optical microscopy. Separately, a solution containing 10 weight percent fluorescein isothiocyanate (FITC) in dimethylsulfoxide (DMSO) was created. Following this, the mold containing the particles was exposed to the FITC solution for one-hour. Excess. FITC was rinsed off the mold surface with DMSO followed by deionized (DI) water. The tagged particles were observed with fluorescence microscopy, with an excitation wavelength of 492 nm and an emission wavelength of 529 nm.

### Example 8

### Encapsulation of Avidin (66 kDa) in 160 nm PEG Particles

A patterned perfluoropolyether (PFPE) mold was generated by pouring a PFPE-dimethacrylate (PFPE-DMA) containing 1-hydroxycyclohexyl phenyl ketone over a silicon substrate patterned with 160-nm cylindrical shapes (see FIG. 14). A poly(dimethylsiloxane) mold was used to confine the liquid PFPE-DMA to the desired area. The apparatus was then subjected to UV light (λ=365 nm) for 10 minutes while under a nitrogen purge. The fully cured PFPE-DMA mold was then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 1 wt % avidin in 30:70 PEG monomethacrylate:PEG diacrylate was formulated with 1 wt % photoinitiator. Following this, 50 μL of this PEG/avidin solution was then placed on the treated silicon wafer and the patterned PFPE mold placed on top of it. The substrate was then placed in a molding apparatus and a small pressure is applied to push out excess PEG-diacrylate/avidin solution. The small pressure in this example was at least about 100 N/cm². The entire apparatus was then subjected to UV light (A=365 nm) for ten minutes while under a nitrogen purge. Avidin-containing PEG particles were observed after separation of the PFPE mold and the treated silicon wafer using fluorescent microscopy.

### Example 9

### Triangular Particles in an Array Functionalized on One Side

A patterned perfluoropolyether (PFPE) mold is generated by pouring a PFPE-dimethacrylate (PFPE-DMA) containing 1-hydroxycydohexyl phenyl ketone over a 6 inch silicon substrate patterned with 0.6 μm×0.8 μm×1 μm right triangles. The substrate is then subjected to UV light (λ=365 nm) for 10 minutes while under a nitrogen purge. The fully cured PFPE-DMA mold is then released from the silicon master. Flat, uniform, non-wetting surfaces are generated by treating a silicon wafer cleaned with “piranha” solution (1:1 concentrated sulfuric acid: 30% hydrogen peroxide (aq) solution) with trichloro(1H,1H,2H,2H-perfluorooctyl) silane via vapor deposition in a desiccator for 20 minutes. Separately, a solution of 5 wt % aminoethyl methacrylate in 30:70 PEG monomethacrylate:PEG diacrylate is formulated with 1 wt % photoinitiator. Following this, 200 μL of this monomer solution is then placed on the treated silicon wafer and the patterned PFPE mold placed on top of it. The substrate is then placed in a molding apparatus and a small pressure is applied to push out excess solution. The small pressure should be at least about 100 N/cm². The entire apparatus is then subjected to UV light (λ=365 nm) for ten minutes while under a nitrogen purge. Aminoethyl methacrylate-containing PEG particles are observed in the mold in an array after separation of the PFPE mold and the treated silicon wafer using optical microscopy. Separately, a solution containing 10 weight percent fluorescein isothiocyanate (FITC) in dimethylsulfoxide (DMSO) is created. Following this, the mold containing the particles is exposed to the FITC solution for one hour. Excess FITC is rinsed off the mold surface with DMSO followed by deionized (DI) water. The array of particles, tagged only on the one face of the mold, will be observed with fluorescence microscopy, with an excitation wavelength of 492 nm and an emission wavelength of 529 nm.

### Example 10

### Microarray Filling through Dipping

A mold of size 0.5×3 cm with 3×3×8 micron pattern was dipped into the vial with 98% PEG-diacrylate and 2% photo initiator solution. After 30 seconds the mold was withdrawn at a rate of approximately 1 mm per second.

Then the mold was put into an UV oven, purged with nitrogen for 15 minutes, and then cured for 15 minutes. The particles were harvested on the glass slide in an array using cyanoacrylate adhesive. No scum was detected and monodispersity of the particle array was confirmed using optical microscope.

### Example 11

### Encapsulation of Plasmid DNA into PEG Particles

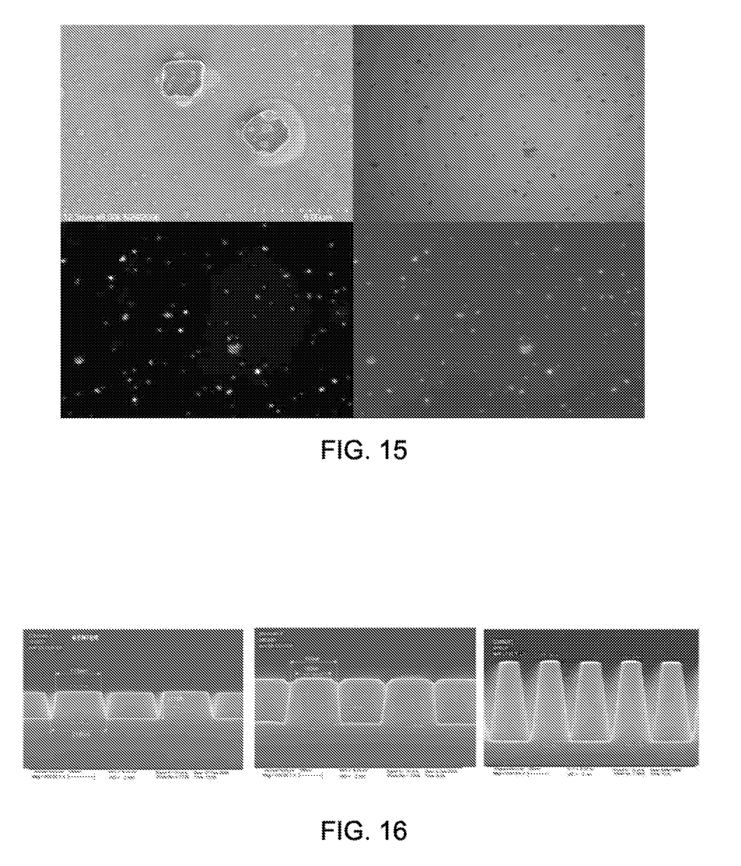

A patterned perfluoropolyether (PFPE) mold was generated by pouring a PFPE-dimethacrylate (PFPE-DMA) containing 1-hydroxycyclohexyl phenyl ketone over a silicon substrate patterned with 2 μm rectangles. A poly(dimethylsiloxane) mold was used to confine the liquid PFPE-DMA to the desired area. The apparatus was then subjected to UV light (λ=365 nm) for 10 minutes while under a nitrogen purge. The fully cured PFPE-DMA mold was then released from the silicon master. Separately, 0.5 μg of flourescein-labelled plasmid DNA (Mirus Biotech) as a 0.25 μg/μL solution in TE buffer and a 2.0 μg of pSV β-galactosidase control vector (Promega) as a 1.0 solution in TE buffer were sequentially added to a mixture composed of acryloxyethyltrimethylammonium chloride (1.2 mg), polyethylene glycol diacrylate (n=9) (10.56 mg), Polyflour 570 (Polysciences, 0.12 mg), diethoxyacetophenone (0.12 mg), methanol (1.5 mg), water (0.31 mg), and N,N-dimethylformamide (7.2 mg). This mixture was spotted directly onto the patterned PFPE-DMA surface and covered with a separated unpatterned PFPE-DMA surface. The mold and surface were placed in molding apparatus, purge with N₂ for ten minutes, and placed under at least 500 N/cm² pressure for 2 hours. The entire apparatus was then subjected to UV light (λ=365 nm) for 40 minutes while maintaining nitrogen purge. These particles were harvested on glass slide using cyanoacrylate adhesive. The particles were purified by dissolving the adhesive layer with acetone followed by centrifugation of the suspended particles (see FIG. 15).

### Example 12

### Fabrication of 200 nm Cylindrical Fluorescently-Tagged 14 Wt % Cationically Charged PEG Particles in a Mold

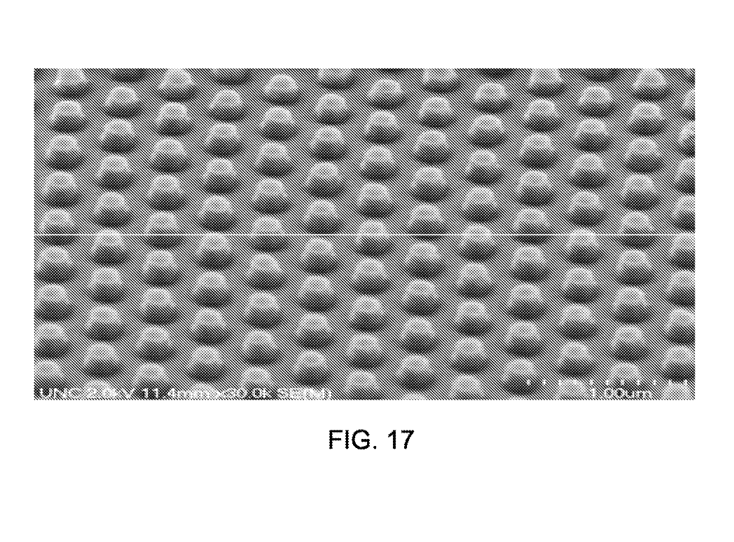

A patterned perfluoropolyether (PFPE) mold is generated by pouring a PFPE-dimethacrylate (PFPE-DMA) containing 2,2-diethoxyacetophenone over a silicon substrate patterned with 200 nm cylindrical shapes (see FIG. 16). The apparatus is then subjected to a nitrogen purge for 10 minutes before the application of UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 14 wt % PEG methacrylate (n=9), 14 wt % 2-acryloxyethyltrimethylammonium chloride (AETMAC), 2 wt % azobisisobutyronitrile (AIBN), and 0.25 wt % rhodamine methacrylate. Flat, uniform, non-wetting surfaces are generated by coating a glass slide with PFPE-dimethacrylate (PFPE-DMA) containing 2,2-diethoxyacetophenone. The slide is then subjected to a nitrogen purge for 10 minutes, then UV light is applied (λ=365 nm) while under a nitrogen purge. The flat, fully cured PFPE-DMA substrate is released from the slide. Following this 0.1 mL of the monomer blend is evenly spotted onto the flat PFPE-DMA surface and then the patterned PFPE-DMA mold placed on top of it. The surface and mold are then placed in a molding apparatus and a small amount of pressure is applied to remove any excess monomer solution. The entire apparatus is purged with nitrogen for 10 minutes, then subjected to UV light (λ=365 nm) for 10 minutes while under a nitrogen purge. Cationically charged PEG nanoparticles are observed after separation of the PFPE-DMA mold and substrate using scanning electron microscopy (SEM). The harvesting process begins by spraying a thin layer of cyanoacrylate monomer onto the PFPE-DMA mold filled with particles. The PFPE-DMA mold is immediately placed onto a glass slide and the cyanoacrylate is allowed to polymerize in an anionic fashion for one minute. The mold is removed and the particles are embedded in an array in the soluble adhesive layer (see FIG. 17), which provides isolated, harvested colloidal particle dispersions upon dissolution of the soluble adhesive polymer layer in acetone if desired.

### Example 13

### Fabrication of 2 μm×2 μm×1 μm Cubic Fluorescently-Tagged 14 Wt % Cationically Charged PEG Particles in a Mold

A patterned perfluoropolyether (PFPE) mold is generated by pouring a PFPE-dimethacrylate (PFPE-DMA) containing 2,2-diethoxyacetophenone over a silicon substrate patterned, with 2 μm×2 μm×1 μm cubic shapes. The apparatus is then subjected to a nitrogen purge for 10 minutes before the application of UV light (λ=365 nm) for 10 minutes while under a nitrogen purge. The fully cured PFPE-DMA mold is then released from the silicon master. Separately, a polyethylene glycol) (PEG) diacrylate (n=9) is blended with 14 wt % PEG methacrylate (n=9), 14 wt % 2-acryloxyethyltrimethylammonium chloride (AETMAC), 2 wt % azobisisobutyronitrile (AIBN), and 0.25 wt % rhodamine methacrylate. Flat, uniform, non-wetting surfaces are generated by coating a glass slider with PFPE-dimethacrylate (PFPE-DMA) containing 2,2-diethoxyacetophenone. The slide is then subjected to a nitrogen purge for 10 minutes, then UV light is applied (λ=365 nm) while under a nitrogen purge. The flat, fully cured PFPE-DMA substrate is released from the slide. Following this 0.1 mL of the monomer blend is evenly spotted onto the flat PFPE-DMA surface and then the patterned PFPE-DMA mold placed on top of it. The surface and mold are then placed in a molding apparatus and a small amount of pressure is applied to remove any excess monomer solution. The entire apparatus is purged with nitrogen for 10 minutes, then subjected to UV light (λ=365 nm) for 10 minutes while under a nitrogen purge. Cationically charged PEG nanoparticles are observed after separation of the PFPE-DMA mold and substrate using scanning electron microscopy (SEM), optical and fluorescence microscopy (excitation λ=526 nm, emission λ=555 nm). The harvesting process begins by spraying a thin layer of cyanoacrylate monomer onto the PFPE-DMA mold filled with particles. The PFPE-DMA mold is immediately placed onto a glass slide and the cyanoacrylate is allowed to polymerize in an anionic fashion for one minute. The mold is removed and the particles are embedded in an array in the soluble adhesive layer, which can provide isolated, harvested colloidal particle dispersions upon dissolution of the soluble adhesive polymer layer in acetone. Particles embedded in the harvesting layer or dispersed in acetone can be visualized by SEM. The dissolved poly(cyanoacrylate) can remain with the particles in solution, or can be removed via centrifugation

### Example 14

### Synthesis of ¹⁴C Radiolabeled 2 μm×2 μm×1 μm Cubic PRINT Particles in a Mold

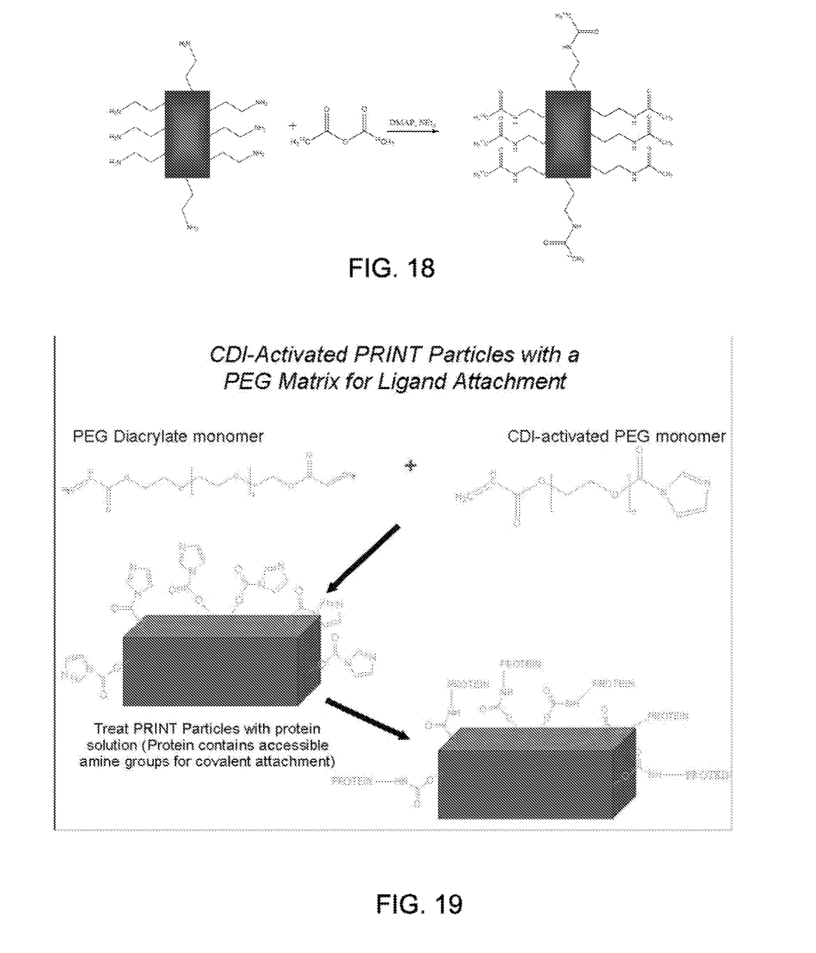

A patterned perfluoropolyether (PFPE) mold is generated by pouring a PFPE-dimethacrylate (PFPE-DMA) containing 2,2-diethoxyacetophenone over a silicon substrate patterned with 2 μm×2 μm×1 μm cubic shapes. The apparatus is then subjected to a nitrogen purge for 10 minutes before the application of UV light (λ=365 nm) for 10 minutes while under a nitrogen purge. The fully cured PFPE-DMA mold is then released from the silicon master. Separately, a poly(ethylene glycol) (PEG) diacrylate (n=9) is blended with 30 wt % 2-aminoethylmethacrylate hydrochloride (AEM), and 1 wt % 2,2-diethoxyacetophenone. The monomer solution is applied to the mold by spraying a diluted (10×) blend of the monomers with isopropyl alcohol. A polyethylene sheet is placed onto the mold, and any residual air bubbles are pushed out with a roller. The sheet is slowly pulled back from the mold at a rate of 1 inch/minute. The mold is then subjected to a nitrogen purge for 10 minutes, then UV light is applied (λ=365 nm) while under a nitrogen purge. The harvesting process begins by spraying a thin layer of cyanoacrylate monomer onto the PFPE-DMA mold filled with particles. The PFPE-DMA mold is immediately placed onto a glass slide and the cyanoacrylate is allowed to polymerize in an anionic fashion for one minute. The mold is removed and the particles are embedded in an array in the adhesive layer. The dry, purified particles are then exposed to ¹⁴C-acetic anhydride in dry dichloromethane in the presence of triethylamine, and 4-dimethylaminopyridine for 24 hours (see FIG. 18). Unreacted reagents are removed via rinsing. Efficiency of the reaction is monitored by measuring the emitted radioactivity in a scintillation vial.

### Example 15

### Forming a Particle in a Mold Containing CDI Linker

A patterned perfluoropolyether (PFPE) mold is generated by pouring a PFPE-dimethacrylate (PFPE-DMA) containing 2,2′-diethoxy-acetophenone over a silicon substrate patterned with 200 nm shapes. The apparatus is then subjected to UV light (λ=365 nm) for 15 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 2,2′-diethoxy-acetophenone. 70 μL of PEG diacrylate monomer and 30 uL of CDI-PEG monomer were mixed. Specifically, the CDI-PEG monomer was synthesized by adding 1,1′-carbonyl diimidazole (CDI) to a solution of PEG (n=400) monomethylacrylate in chloroform. This solution was allowed to stir overnight. This solution was then further purified by an extraction with cold water. The resulting CDI-PEG monomethacrylate was then isolated via vacuum. Flat, uniform, non-wetting surfaces are generated by pouring a PFPE-dimethacrylate (PFPE-DMA) containing 2,2′-diethoxy-acetophenone over a silicon wafer and then subjected to UV light (λ=365 nm) for 15 minutes while under a nitrogen purge. Following this, 50 μL of the PEG diacrylate solution is then placed on the non wetting surface and the patterned PFPE mold placed on top of it. The substrate is then placed in a molding apparatus and a small pressure is applied to push out excess PEG-diacrylate solution. The entire apparatus is then subjected to UV light (λ=365 nm) for 15 minutes while under a nitrogen purge. Particles are observed after separation of the PFPE mold. The particles were harvested utilizing a sacrificial adhesive layer and verified via DIC microscopy. This linker can be utilized to attach an amine containing target onto the particle (see FIG. 19).

### Example 16

### Fabrication of PEG Particles that Target the HER2 Receptor

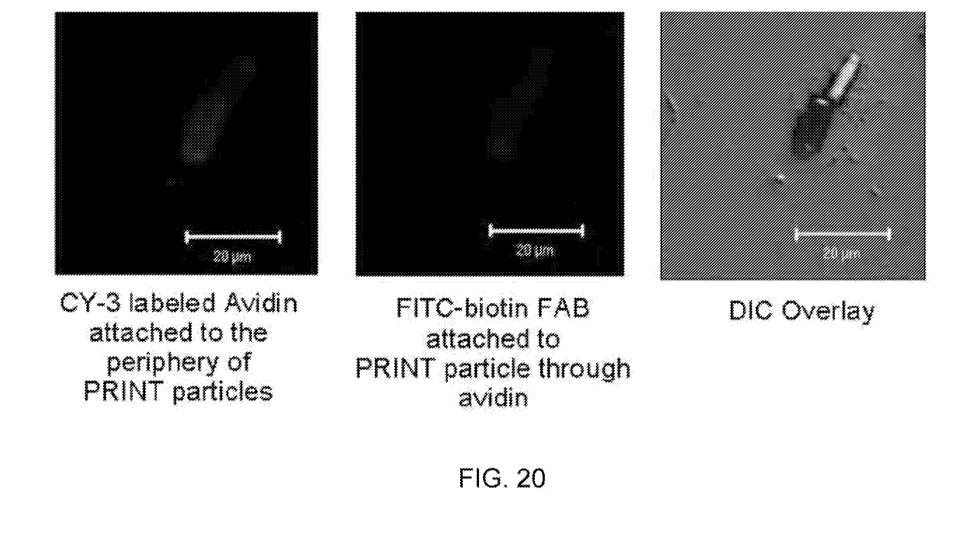

A patterned perfluoropolyether (PFPE) mold is generated by pouring a PFPE-dimethacrylate (PFPE-DMA) containing 2,2′-diethoxy-acetophenone over a silicon substrate patterned with 200 nm shapes. The apparatus is then subjected to UV light (λ=365 nm) for 15 minutes while under a nitrogen purge. The fully cured PFPE-DMA mold is then released from the silicon master. Separately, a poly(ethylene glycol) (PEG) diacrylate (n=9) is blended with 1 wt % of a photoinitiator, 2,2′-diethoxy-acetophenone. 70 μL of PEG diacrylate monomer and 30 of CDI-PEG monomer were mixed. Specifically, the CDI-PEG monomer was synthesized by adding 1,1′-carbonyl diimidazole (COI) to a solution of PEG (n=400) monomethylacrylate in chloroform. This solution was allowed to stir overnight. This solution was then further purified by an extraction with cold water. The resulting CDI-PEG monomethacrylate was then isolated via vacuum. Flat, uniform, non-wetting surfaces are generated by pouring a PFPE-dimethacrylate (PFPE-DMA) containing 2,2′-diethoxy-acetophenone over a silicon wafer and then subjected to UV light (A=365 nm) for 15 minutes while under a nitrogen purge. Following this, 50 μL of the PEG diacrylate solution is then placed on the non wetting surface and the patterned PFPE mold placed on top of it. The substrate is then placed in a molding apparatus and a small pressure is applied to push out excess PEG-diacrylate solution. The entire apparatus is then subjected to UV light (λ=365 nm) for 15 minutes while under a nitrogen purge. Particles are observed after separation of the PFPE mold. The particles were harvested utilizing a sacrificial adhesive layer and verified via DIC microscopy. These particles containing the CDI linker group were subsequently treated with and aqueous solution of fluorescently tagged avidin. These particles were allowed to stir at room temperature for four hours. These particles were then isolated via centrifugation and rinsed with deionized water. These avidin labeled particles were then treated with biotinylated FAB fragments. Attachment was confirmed via confocal microscopy (see FIG. 20).

1. A nanoarray comprising:
a surface having a plurality of features;
wherein each feature includes at least one probe; and
wherein each feature has a predetermined shape and has a broadest linear dimension of less than about 2 micrometers.

2. The nanoarray of claim 1, wherein each feature has a broadest linear dimension of less than about 1 micrometer.

3.-12. (canceled)

13. The nanoarray of claim 1, further comprising land area between adjacent features wherein the land area is less than about 750 nanometers.

14.-20. (canceled)

21. The nanoarray of claim 1, wherein the surface comprises perfluoropolyether.

22. (canceled)

23. The nanoarray of claim 1, wherein at least one feature includes a first probe and a second feature includes a second probe that is different from the first probe.

24. The nanoarray of claim 1, wherein each feature comprises:
a cavity in the surface, wherein the cavity has a predetermined size and shape, and
a composition discretely contained in the cavity, where the composition includes the at least one probe.

25.-35. (canceled)

36. The nanoarray of claim 1, further comprising land area extending between adjacent features wherein the land area is non-fouling.

37.-53. (canceled)

54. A method of fabricating a nanoarray, comprising:
introducing a composition into a plurality of cavities in a first mold, wherein the mold is fabricated from a non-wetting polymer and wherein each cavity has a predetermined shape and a largest linear dimension of less than about 5 micrometers;
coupling a probe to the composition in the cavities in the first mold to form a feature.

55.-60. (canceled)

61. The method of claim 54, further comprising reacting a target with the probe in the cavity.

62. (canceled)

63. The method of claim 54, further comprising fabricating a second mold having cavities; and
positioning the second mold adjacent the first mold.

64-66. (canceled)

67. The method of claim 54, further comprising contacting a substrate to the features in the mold and harvesting the features from the mold cavities such that the features are coupled to the substrate in a predetermined array.

68. A method of identifying a target in a sample, comprising:
contacting a sample comprising one or more targets with a nanoarray, wherein the nanoarray comprises;
a surface with a plurality of features, wherein each feature includes at least one probe for coupling with a target, and wherein each feature has a predetermined shape and has a broadest linear dimension of less than about 5 micrometers;
allowing a target having an affinity for a probe to bind with the probe;
detecting the features associated with the target bound probes; and
cross referencing the detected target bound probes with a library of what probe is associated with the feature to determine a composition of the target.

69.-77. (canceled)

78. A delivery composition, comprising:
a substrate; and
a plurality of particles, wherein each particle of the plurality of particles comprises a substantially similar three dimensional shape and includes a broadest dimension less than about 20 micrometers;
wherein the plurality of particles are arranged on a surface of the substrate in a predetermined ordered array and the plurality of particles can be removed from the surface of the substrate for delivery to a patient.

79. The delivery composition of claim 78, wherein each particle of the plurality of particles is spaced from adjacent particles of the plurality of particles in the ordered array by less than about 5 micrometers.

80. The delivery composition of claim 78, wherein each particle of the plurality of particles is less than about 1 micrometer in diameter and each particle of the plurality of particles is spaced from adjacent particles of the plurality of particles by less than about 1 micrometer.
